(19) United States
(12) Patent Application Publication
(10) Pub. No.: US 2017/0057877 A1
(43) Pub. Date: Mar. 2, 2017

(54) METHODS OF SELECTIVE NANOPARTICLE DIFFUSION INTO A POLYCRYSTALLINE DIAMOND BODY AND SO FORMED POLYCRYSTALLINE DIAMOND COMPACTS

(71) Applicant: US Synthetic Corporation, Orem, UT (US)

(72) Inventor: Craig H. Cooley, Saratoga Springs, UT (US)

(73) Assignee: US SYNTHETIC CORPORATION, Orem, UT (US)

(21) Appl. No.: 14/175,366

(22) Filed: Feb. 7, 2014

(51) Int. Cl. C04B 35/528; F16C 33/04; E21B 10/573

(52) U.S. Cl. CPC C04B 35/528; E21B 10/5735; F16C 33/043

(57) ABSTRACT

Embodiments of the invention relate to polycrystalline diamond bodies having nanoparticles disposed in a region therein, and methods of fabricating the same.

### BACKGROUND

Wear-resistant, superabrasive compacts are utilized in a variety of mechanical applications. For example, polycrystalline diamond compacts (“PDCs”) are used in drilling tools (e.g., cutting elements, gage trimmers, etc.), machining equipment, bearing apparatuses, wire-drawing machinery, and in other mechanical apparatuses.

PDCs have found particular utility as superabrasive cutting elements in rotary drill bits, such as roller cone drill bits and fixed cutter drill bits. A PDC cutting element typically includes a superabrasive diamond layer (also known as a diamond body or table). The diamond body is formed and bonded to a substrate using an ultra-high pressure, ultra-high temperature (“HPHT”) process. The substrate is often brazed or otherwise joined to an attachment member, such as a stud or a cylindrical backing The substrate is typically made of tungsten or tungsten carbide.

A rotary drill bit typically includes a number of PDC cutting elements affixed to a drill bit body. A stud carrying the PDC may be used as a PDC cutting element when mounted to a bit body of a rotary drill bit by press-fitting, brazing, or otherwise securing the stud into a receptacle formed in the bit body. The PDC cutting element may also be brazed directly into a preformed pocket, socket, or other receptacle formed in the bit body.

Conventional PDCs are normally fabricated by placing a cemented carbide substrate into a container or cartridge with a volume of diamond crystals positioned on a surface of the cemented carbide substrate. A number of such cartridges may be loaded into an HPHT press. The substrates and volume of diamond crystals are then processed under HPHT conditions in the presence of a catalyst material that causes the diamond crystals to bond to one another to form a matrix of bonded diamond crystals defining a diamond body. The catalyst material is often a metal-solvent catalyst, such as cobalt, nickel, iron, or alloys thereof that is used for promoting intergrowth of the diamond crystals.

In one conventional approach, a constituent of the cemented carbide substrate, such as cobalt from a cobalt-cemented tungsten carbide substrate, liquefies and sweeps from a region adjacent to the volume of diamond crystals into interstitial regions between the diamond crystals during the HPHT process. The cobalt acts as a catalyst to promote intergrowth between the diamond crystals, which results in formation of bonded diamond crystals. Often, a solvent catalyst may be mixed with the diamond crystals prior to subjecting the diamond crystals and substrate to the HPHT process. During the HPHT process other components of the cemented carbide substrate, such as tungsten and carbon, may also migrate into the interstitial regions between the diamond crystals. The diamond crystals become mutually bonded to form a matrix of polycrystalline diamond (“PCD”, also referred to as a PCD body or PCD table), with interstitial regions between the bonded diamond crystals being occupied by the solvent catalyst.

The presence of the solvent catalyst in the diamond body is believed to reduce the thermal stability of the diamond body at elevated temperatures. For example, the difference in thermal expansion coefficient between the diamond grains and the solvent catalyst is believed to lead to chipping or cracking in the PDC during drilling or cutting operations, which consequently can degrade the mechanical properties of the PDC or cause failure. Additionally, some of the diamond grains can undergo a chemical breakdown or back-conversion to graphite via interaction with the solvent catalyst. At extremely high temperatures, portions of diamond crystals may transform to carbon monoxide, carbon dioxide, graphite, or combinations thereof, thus, degrading the mechanical properties of the PDC. One conventional approach for improving the thermal stability of PDCs is to at least partially remove the solvent catalyst from the PDC by acid leaching.

Therefore, manufacturers and users of PDCs continue to seek PDCs having improved thermal stability.

### SUMMARY

Embodiments of the invention relate to methods of fabricating nanoparticle infiltrated PCD bodies and PDCs in which the nanoparticle infiltrated/infused region impedes infiltration/infusion of a metallic infiltrant under HPHT conditions, resulting PCD bodies and PDCs, and applications for such PCD bodies and PDCs. Infiltrating/infusing at least a portion of a PCD body with nanoparticles prior to bonding the PCD body to a substrate may improve the thermal and/or mechanical properties of the resulting PDC.

In an embodiment, a method of fabricating a PDC includes forming a PCD body including a plurality of bonded diamond grains defining a plurality of interstitial spaces in which a catalyst (e.g., metal-solvent catalyst) is disposed. The PCD body may then be leached to at least partially remove the catalyst therefrom. The at least partially leached PCD body may then be infiltrated/infused with nanoparticles to limit or reduce subsequent infiltration of another material into a portion of the at least partially leached PCD body. The at least partially leached and nanoparticle infiltrated PCD body may be bonded to substrate in a second HPHT process to form a PDC. The resulting PCD body of the PDC includes at least a region having constituent infiltrant (i.e., infiltrant comprising a constituent of a substrate) therein, and a region containing nanoparticles therein. Such regions may overlap, may be the same region, or may be separate.

In an embodiment, a PDC includes a substrate including a constituent infiltrant therein and a PCD body defining an upper surface and a back surface spaced therefrom. The PCD body includes a plurality of bonded diamond grains defining plurality of interstitial spaces therebetween, a constituent infiltrant infiltrated region extending from at least the back surface to an intermediate depth, and a nanoparticle containing region extending from at least the intermediate depth toward the upper surface. The constituent infiltrant infiltrated region includes the constituent infiltrant occupying at least a portion of the plurality of interstitial spaces therein. The nanoparticle containing region includes nanoparticles occupying at least a portion of the plurality of interstitial spaces therein.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1A is an isometric view of a PDC according to an embodiment.

FIG. 1B is a cross-sectional view of a plurality of diamond particles according to an embodiment.

FIG. 1C is a cross-sectional view of a PCD body having bonded diamond grains according to an embodiment.

FIG. 1D is a cross-sectional view of a PCD body that has been at least partially leached.

FIG. 1E is a cross-sectional view of an at least partially leached PCD body that has been at least partially infiltrated with nanoparticles, according to an embodiment.

FIG. 1F is an enlarged cross-sectional cut-away view of a microstructural section of a portion of the PCD body depicted in FIG. 1E.

FIG. 1G is a cross-sectional view of a PDC including the PCD body from FIG. 1E bonded to a substrate, according to an embodiment.

FIG. 1H is a cross-sectional view of an at least partially leached PCD body that has been at least partially infiltrated with nanoparticles, according to an embodiment.

FIG. 1I is a cross-sectional view of a PDC including the PCD body from FIG. 1H bonded to a substrate, according to an embodiment.

FIG. 1J is a cross-sectional view of an at least partially leached PCD body that has been at least partially infiltrated with nanoparticles to include a gradient of infiltration, according to an embodiment.

FIG. 1K is a cross-sectional view of an embodiment of an at least partially leached PCD body having nanoparticles in at least a portion of the leached portion.

FIG. 1L is a cross-sectional view of an embodiment of an at least partially leached PCD body having nanoparticles in at least a portion of the leached portion.

FIG. 1M is a cross-sectional view of an embodiment of an at least partially leached PCD body having nanoparticles in at least a portion of the leached portion.

FIG. 1N is a cross-sectional view of an embodiment of a PDC including a PCD body that has been at least partially infiltrated with nanoparticles, bonded to a PCD body, and at least partially leached in a region thereof.

FIG. 1O is an enlarged cross-sectional cut-away view of a microstructural section of a portion of a PCD body depicted.

FIG. 1P is an enlarged cross-sectional cut-away view of a microstructural section of a portion of the PCD body depicted in FIG. 1L.

FIG. 2A is a cross-sectional view of an infiltration apparatus according to an embodiment.

FIG. 2B is a cross-sectional view of an infiltration apparatus according to an embodiment.

FIG. 2C is a cross-sectional view of an infiltration apparatus according to an embodiment.

FIG. 3 is a flow diagram of a method of making a PDC having a nanoparticle containing region according to an embodiment.

FIG. 4 is an isometric view of a rotary drill bit according to an embodiment that may employ one or more of the PDCs fabricated according to any of the embodiments disclosed herein.

FIG. 5 is a top elevation view of the rotary drill bit shown in FIG. 4.

FIG. 6 is an isometric cut-away view of a thrust-bearing apparatus according to an embodiment, which may utilize any of the disclosed PDCs fabricated according to any of the embodiments disclosed herein as bearing elements.

FIG. 7 is an isometric cut-away view of a radial bearing apparatus according to an embodiment, which may utilize any of the disclosed PDCs fabricated according to any of the embodiments disclosed herein as bearing elements.

### DETAILED DESCRIPTION

Embodiments of the invention relate to PDCs including a nanoparticle infiltrated/infused PCD body (e.g., PCD table), and methods of fabricating such PCD and PDCs. The disclosed PCD bodies include a nanoparticle containing region or portion in which infiltration or diffusion of a subsequent material through or past the nanoparticle containing region is limited or prevented. The disclosed PDCs may be used in a variety of applications, such as rotary drill bits, bearing apparatuses, wire-drawing dies, machining equipment, and other articles and apparatuses.

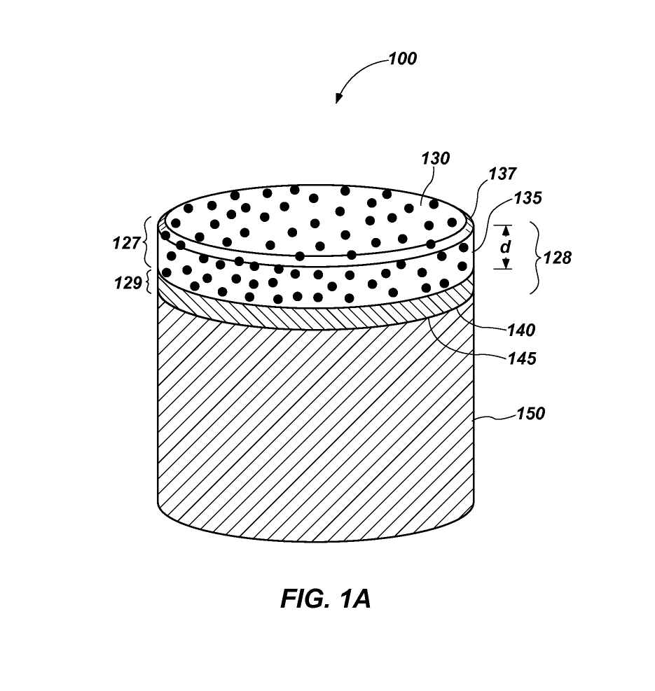

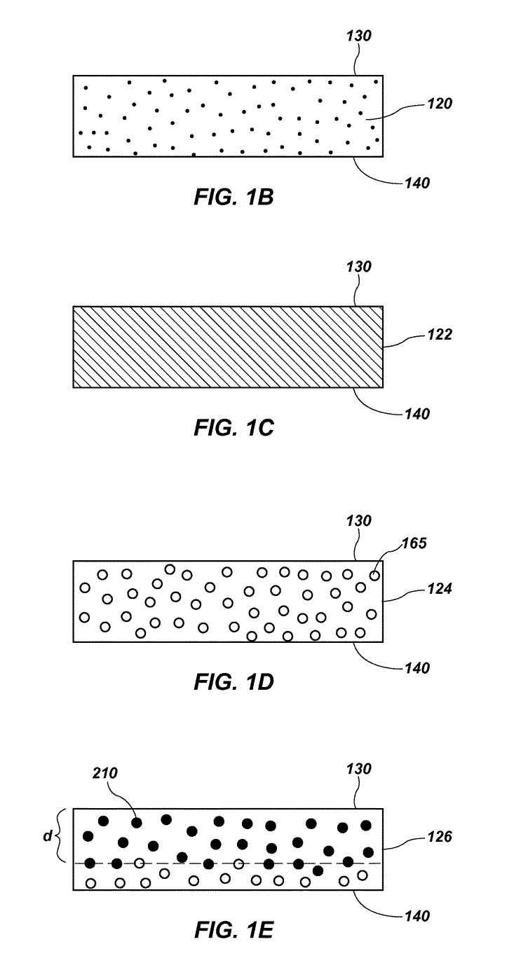

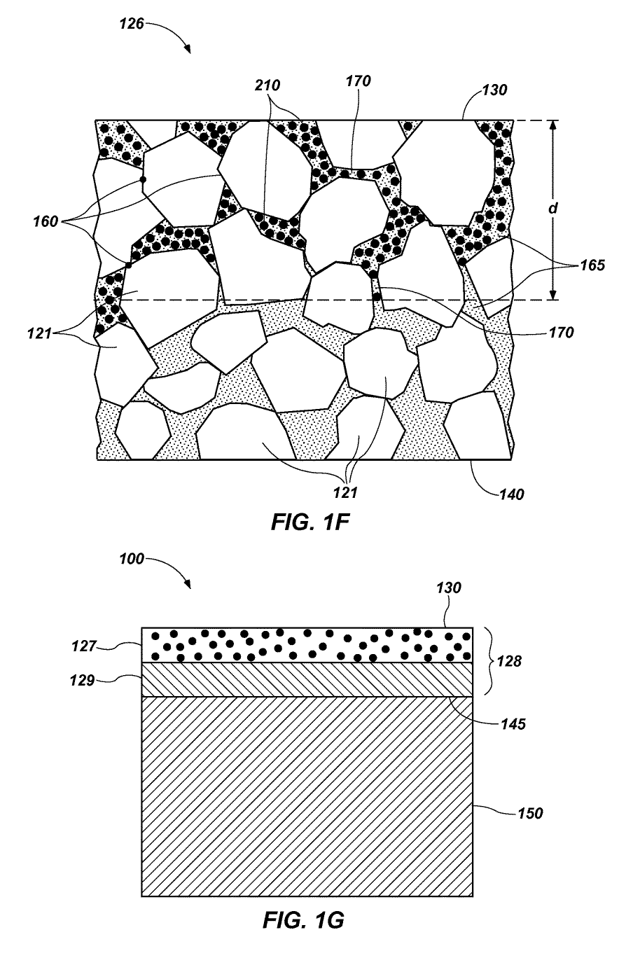

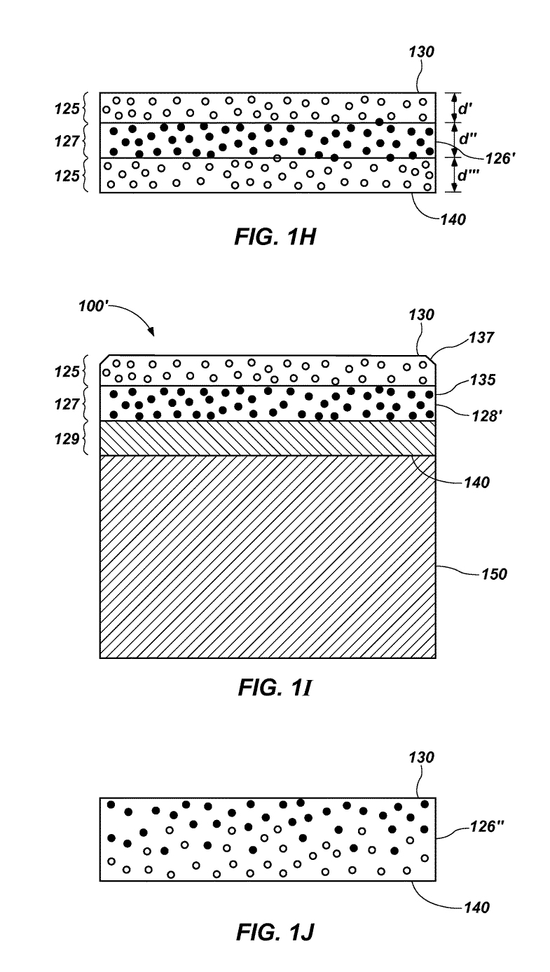

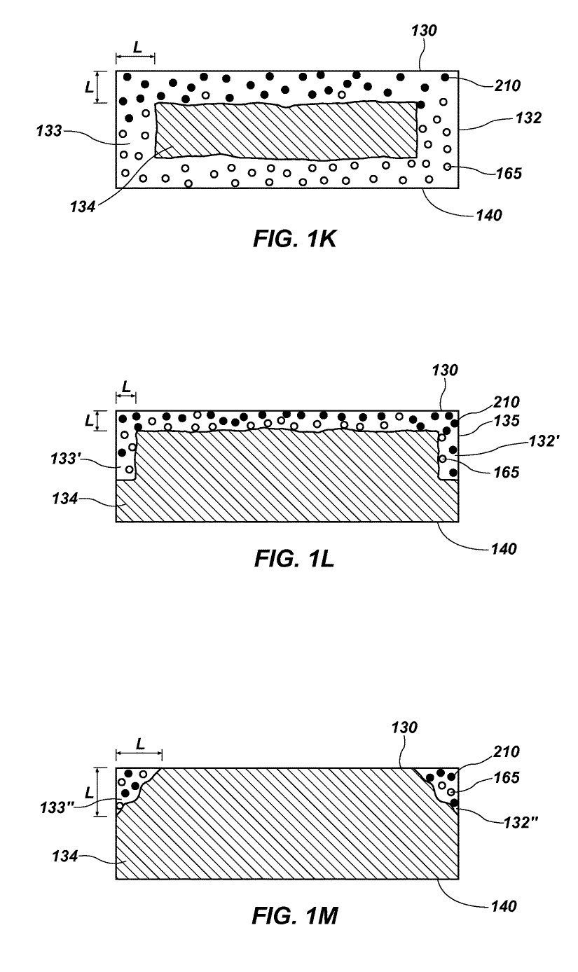

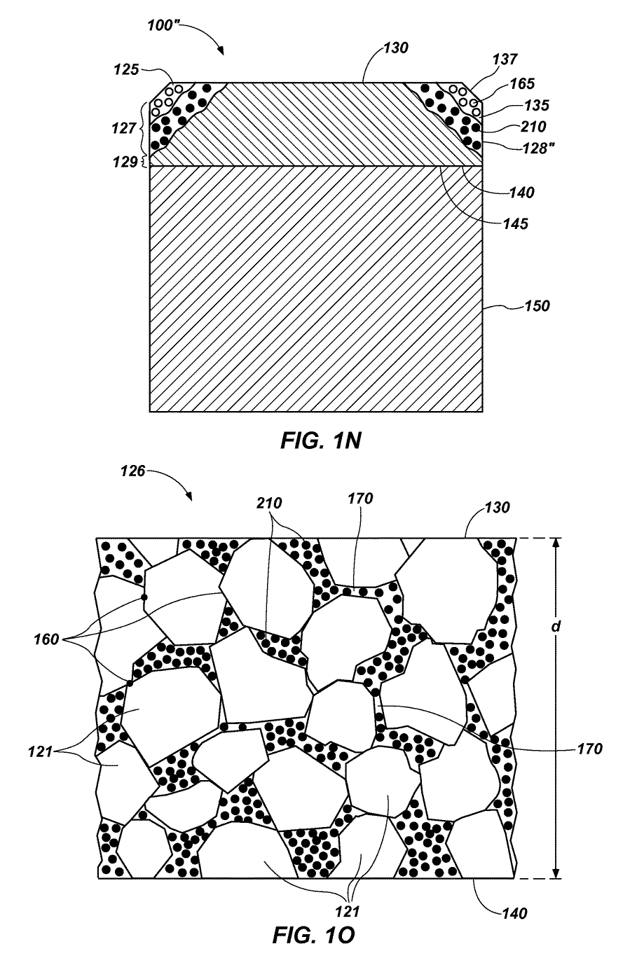

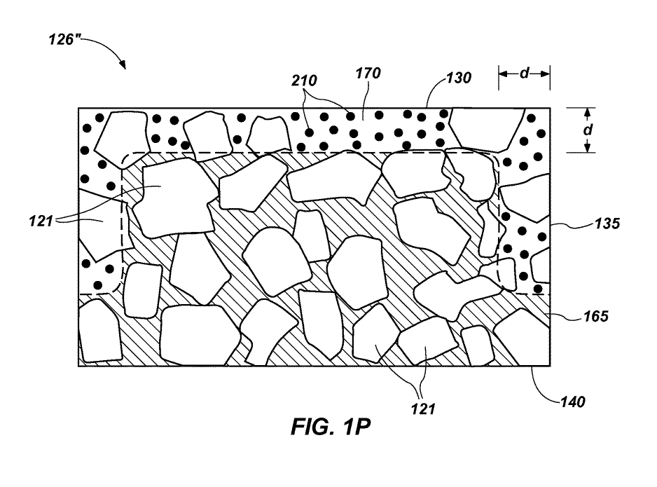

FIG. 1A is an isometric view of an embodiment of a PDC 100 including a nanoparticle infiltrated/infused PCD body having at least one type of nanoparticles and at least one constituent infiltrant disposed at least in different respective regions therein. The PDC 100 includes a bonded and infiltrated PCD body 128 including a plurality of bonded diamond grains having diamond-to-diamond bonding (e.g., sp³ bonding) therebetween. The plurality of bonded diamond grains defines a plurality of interstitial spaces/regions which may be interconnected between bonded diamond grains. The PCD body 128 may include an upper surface 130, a back surface 140, and at least one lateral surface 135 therebetween. In an embodiment, a chamfer 137 may be formed between the upper surface 130 and the at least one lateral surface 135. The chamfer 137 may extend peripherally around an edge of the PCD body adjacent to the upper surface 130 thereof. In an embodiment, the bonded and infiltrated PCD body 128 includes a nanoparticle-containing region 127 disposed in a first portion of the interstitial regions, with the nanoparticle-containing region 127 extending from the upper surface 130 into the PCD body. The PCD body 128 may be infiltrated/infused with nanoparticles from the upper surface 130 to an intermediate depth d. For example, as discussed in more detail below, suitable nanoparticles may include, by way of non-limiting example, nanodiamond particles (e.g., ultra-dispersed diamond particles), metals, metalloids, metal oxides, metal carbides, metal nitrides, glass, or combinations of the foregoing. For example, graphite, boron nitride, silicon carbide, refractory metals, or combinations thereof may comprise suitable nanoparticles. As used herein, the term “infiltrated” and variations thereof are intended to carry the same meaning as and may be used interchangeably with “infused” and variations thereof.

The bonded and infiltrated PCD body 128 includes a constituent infiltrant infiltrated region 129 disposed in a second portion of the interstitial regions, with the constituent infiltrant infiltrated region 129 extending inwardly from the back surface 140. The constituent infiltrant infiltrated region 129 may extend inwardly from the back surface 140 to at least the intermediate depth d. The nanoparticle infiltrated region 129 may prevent, limit, or impede infiltration/infusion of constituents from a substrate 150 from infiltrating/infusing into a PCD body beyond or into the nanoparticle-containing region 127, thereby creating a more thermally-stable region (e.g., such that it may not need to be subsequently leached). Optionally, nanoparticle-containing region 127 may be leached. In an embodiment, the constituent infiltrant infiltrated region 129 may be formed at least partially by the constituent infiltrant (e.g., cobalt from a cobalt-cemented tungsten carbide substrate) sweeping into the interstitial spaces of the PCD body from the substrate 150 at an interfacial surface 145 thereof.

The bonded and infiltrated PCD body 128 is bonded to the substrate 150 at the interfacial surface thereof. Although the upper surface 130 and the back surface 140 are illustrated as being substantially planar, the upper surface 130 and/or the back surface 140 may be nonplanar (e.g., convex, grooved, dimpled, textured, concave, or combinations thereof) and a working region of the bonded and infiltrated PCD body 128 may include peripheral portions of the nanoparticle containing region(s) 127. Suitable materials for the substrate 150 include cemented carbides, such as titanium carbide, niobium carbide, tantalum carbide, vanadium carbide, tungsten carbide, or combinations of any of the preceding carbides cemented with iron, nickel, cobalt, or alloys thereof. In an embodiment, the substrate 102 may comprise cobalt-cemented tungsten carbide.

FIGS. 1B-1N illustrate one or more embodiments for fabricating a PDC. Referring to FIG. 1B, an embodiment of a plurality of diamond particles before being subjected to a first HPHT process is illustrated. The PCD body 122 as shown in FIG. 1C may be fabricated by subjecting the plurality of diamond particles 120 (e.g., diamond particles having an average particle size between 0.5 μm to about 150 μm) to a first HPHT process to bond (i.e. sinter) the diamond particles together. The first HPHT process may include sintering the diamond particles 120 in the presence of a catalyst, such as, but not limited to, a metal-solvent catalyst, including cobalt, nickel, iron; a carbonate catalyst; or a combination of the preceding catalysts, to facilitate intergrowth between the diamond particles 120 and form the PCD body 122 (FIG. 1C). The PCD body 122 may include directly bonded-together diamond grains 121 (e.g., exhibiting sp³ bonding) substantially as shown in FIG. 1F defining interstitial spaces therebetween, having catalyst disposed within at least a portion of the interstitial spaces. In order to effectively bond the plurality diamond particles 120 under HPHT conditions, the diamond particles 120 shown in FIG. 1B, may be placed in a pressure transmitting medium, such as a refractory metal can, graphite structure, pyrophyllite or other pressure transmitting structure, or another suitable container or supporting element. The pressure transmitting medium, including the diamond particles 120, may be subjected to the first HPHT process using an HPHT press at a temperature of at least about 1000° C. (e.g., about 1300° C. to about 1600° C.) and a cell pressure of at least 4 GPa (e.g., about 5 GPa to about 10 GPa, about 7 GPa to about 9 GPa) for a time sufficient to sinter the diamond particles 120 and form a PCD body 122 substantially as shown in FIG. 1C. Further details about HPHT processing techniques that may be used to practice the embodiments disclosed herein are disclosed in U.S. Pat. No. 7,866,418, which is incorporated herein, in its entirety, by reference.

A catalyst may be provided in particulate form mixed with the diamond particles, as a thin foil placed adjacent to the mass of diamond particles, from a cemented carbide substrate including a metal-solvent catalyst therein (e.g., cobalt from a cobalt-cemented tungsten carbide substrate), or combinations of the foregoing. The PCD body 122 may be formed alone as described above or integrally formed on a substrate. In an embodiment, the diamond particles 120 may be positioned adjacent to the substrate, wherein the substrate includes catalyst therein. Both the plurality of diamond particles 120 and a substrate may be placed in a pressure transmitting medium substantially as described above, wherein the plurality of diamond particles 120 and the substrate are positioned adjacent to one another. The pressure transmitting medium, including the diamond particles 120 and substrate, are subjected to the first HPHT process substantially as described above, wherein the diamond particles 120 and substrate bond together when the catalyst material from the substrate sweeps into the diamond particles to both catalyze diamond-to-diamond bonding as described above and subsequently cools in the interstitial regions of the PCD body. The amount of catalyst that infiltrates into the resulting PCD body depends at least partially on the size and/or distribution of the interstitial regions in the PCD body. In such and embodiment, it may be necessary to remove the PCD body from the substrate in order to perform the subsequent acts described herein on the PCD body such as, for example, leaching and/or nanoparticle infiltration. In other embodiments, at least some of the subsequent acts described herein may be performed with the PCD body remaining bonded to the substrate.

The diamond particle size distribution of the plurality of diamond particles 120 may exhibit a single mode, or may be a bimodal or greater grain size distribution. In an embodiment, the diamond particles 120 may comprise a relatively larger size and at least one relatively smaller size. As used herein, the phrases “relatively larger” and “relatively smaller” refer to particle sizes (by any suitable method) that differ by at least a factor of two (e.g., 30 μm and 15 μm). According to various embodiments, the diamond particles 120 may include a portion exhibiting a relatively larger average particle size (e.g., 200 μm, 50 μm, 40 μm, 30 μm, 20 μm, 15 μm, 12 μm, 10 μm, 8 μm) and another portion exhibiting at least one relatively smaller average particle size (e.g., 6 μm, 5 μm, 4 μm, 3 μm, 2 μm, 1 μm, 0.5 μm, less than 0.5 μm, 0.1 μm, less than 0.1 μm). In an embodiment, the diamond particles 120 may include a portion exhibiting a relatively larger average particle size between about 10 μm and about 40 μm and another portion exhibiting a relatively smaller average particle size between about 1 μm and 4 μm. In some embodiments, the diamond particles 120 may comprise three or more different average particle sizes (e.g., one relatively larger average particle size and two or more relatively smaller average particle sizes), without limitation.

It is noted that the diamond grain size of the as-sintered diamond particles (i.e., diamond grains) may differ from the average particle size of the mass of diamond particles prior to the first HPHT process due to a variety of different physical processes, such as grain growth, diamond particle fracturing, carbon provided from another carbon source (e.g., dissolved carbon in the metal-solvent catalyst), or combinations of the foregoing.

The interstitial region size or average interstitial region size may depend at least partially on the average diamond particle size or the smallest average diamond particle size used in a multimodal diamond particle mixture (i.e., diamond particle mixture having more than one average diamond particle size mixed therein). Interstitial regions and bonded diamond grains may collectively define pore throats between the interstitial regions. Pore throats are the openings connecting adjacent interstitial regions. Smaller pore throats may inhibit infiltration of larger materials into PCD bodies, while larger pore throats will allow such infiltration. Pore throat sizes may vary for a number of reasons including by way of non-limiting example, the size or sizes of the diamond particle sizes used, the shape of the diamond particles used, the extent of diamond-to-diamond bonding between diamond particles, HPHT sintering conditions, or combinations of the foregoing. Pore throat sizes may include sub-nanometer (nm) scale pore throats to micrometer scale pore throats. In an embodiment, an average pore throat size may be achieved. According to various embodiments, pore throats may exhibit an average size smaller than about 20 μm, 5 μm, 1 μm, 500 nm, 200 nm, 100 nm, 50 nm, 25 nm, 15 nm, 10 nm 5, nm, 2 nm, 1 nm, and 500 pm. Pore throat characteristics may be analyzed and determined using porosimetry techniques, including those described in U.S. Patent Application No. 61/846,138 filed on 15 Jul. 2013, which is incorporated herein, in its entirety, by this reference. In an embodiment, manufacturing a PCD body may include selecting and/or using a specific size of diamond powder to obtain a specific interstitial region distribution, size, or average interstitial region size. In an embodiment, manufacturing a PCD body may include selecting and/or using a specific size of diamond powder to obtain specific pore throat sizes, or average pore throat sizes.

FIG. 1C illustrates a cross-sectional view of the PCD body 122 including bonded diamond grains defining interstitial spaces having the catalyst disposed therein. In an embodiment, the PCD body 122 may be formed by a first HPHT sintering process substantially as described above. Catalyst material may sweep through substantially the entirety of the diamond particles 120 subjected to HPHT conditions or only a portion of the diamond particles 120 subjected to HPHT conditions. In an embodiment, the PCD body 122 includes catalyst material within the interstitial spaces between the bonded diamond grains. In an embodiment, the catalyst material includes at least one of a metal-solvent catalyst from the group VIIIB elements (e.g., cobalt, iron, nickel, or alloys thereof); a carbonate catalyst including, but not limited to, alkali metal carbonates, alkaline earth metal carbonates, or combinations thereof; or combinations of the foregoing. The carbonate catalyst may be partially or substantially completely converted to a corresponding oxide of Li, Na, K, Be, Mg, Ca, Sr, Ba or combinations thereof after subjecting the plurality of diamond particles 120 to HPHT conditions. In an embodiment, a metal-solvent catalyst material such as cobalt, for example, is selected and used to catalyze diamond-to-diamond bonding in a PCD body, wherein the cobalt is distributed in at least a portion of the interstitial regions of the resulting PCD body after the first HPHT process.

While the catalyst material promotes diamond-to-diamond bond growth between diamond particles, the catalyst material disposed within the interstitial spaces created by bonded diamond grains may decrease the thermal stability and/or mechanical strength of a PCD body in some circumstances. A catalyst material having a higher coefficient of thermal expansion than the diamond may cause the PCD body to chip, crack, spall, or fail during use. Therefore, it may be desirable to control the extent and/or depth of catalyst infiltration into a PCD body. PCD bodies having cobalt disposed therein may experience cracking or failure at temperatures above about 700-800° C. due to cobalt's higher coefficient of thermal expansion than the bonded diamond grains. The expansion of cobalt may exert stresses on the bonded diamond grains from the interstitial spaces therein, resulting in chipping, cracking, spalling, and failure of the PCD body. Therefore, it may be desirable to leach the cobalt or other catalyst material from a PCD body.

FIG. 1D is a cross-sectional view of an embodiment of an at least partially leached PCD body 124 that is substantially free of catalyst from at least a portion of the interstitial spaces therein. For example, the amount of the metal-solvent catalyst remaining in the PCD body 124 after leaching may be about 0 to about 3 weight % (“wt %”), such as about 0.7 wt % to about 1.0 wt %. As a result of the metal-solvent catalyst being depleted from PCD body 122, the resulting at least partially leached PCD body 124 is relatively more thermally-stable than an unleached PCD body 122.

In an embodiment, PCD body 122 may be rendered substantially free of the catalyst disposed therein by subjecting the PCD body to a leaching process. Conventional leaching processes include disposing (i.e., partially or completely immersing) the PCD body 122 including the catalyst therein into a leaching agent configured to at least partially remove the catalyst from the PCD body 122 to a desired depth. Suitable leaching vessels may include a pressure vessel, a stainless steel vessel, a stainless steel vessel lined with PTFE (i.e., Teflon®) or another lining suitable to withstand acidic conditions at high temperatures, or combinations of the foregoing. In embodiments, the leaching agent may comprise one or more of aqua regia, hydrochloric acid, nitric acid, hydrofluoric acid, other suitable acids, supercritical fluids, or combinations thereof. In an embodiment, the leaching agent and PCD body 122 may be subjected to elevated temperature and/or pressure. For example, in an embodiment, the PCD body 122 having catalyst therein (depicted in FIG. 1C) may be immersed in hot acid for about 2 to about 7 days (e.g., about 3, 5, or 7 days) or for a few weeks (e.g., about 4-6 weeks), depending on the leaching process employed, to form the least partially leached PCD body 124 (depicted in FIG. 1D).

In an embodiment, leaching the catalyst from the PCD body 122 may be accomplished by pressurized leaching. In an embodiment, the PCD body 122 may be subjected to or otherwise soaked in a leaching agent substantially as described above under elevated pressure and/or elevated temperature conditions to leach the catalyst therefrom. In an embodiment, the PCD body 122 and the leaching agent may be disposed in a sealed leaching vessel comprising a pressure vessel including stainless steel construction optionally having a PTFE liner therein. The contents of, or the entire leaching vessel may be subjected to elevated temperature, thereby raising the vapor pressure inside of the pressure vessel, thereby increasing the rate at which the PCD body is leached. In an embodiment, the PCD body 122 may be leached in a matter of hours under elevated temperature and elevated pressure rather than days or weeks in conventional leaching processes. In an embodiment, the PCD body 122 may be leached using a leaching agent having a supercritical component in which the leaching is agent brought to a supercritical state by elevating the pressure and temperature of the leaching agent having a supercritical component. Leaching may be accomplished using supercritical fluid according to leaching methods described in U.S. Patent Application No. 61/897,764 filed on 30 Oct. 2013, the disclosure of which is incorporated herein, in its entirety, by this reference.

In embodiments such as those depicted in FIGS. 1K-1M, the leached region may only extend a discrete depth or into a discrete region of the PCD body. For example, as shown in FIG. 1K, an at least partially leached and infiltrated PCD body 132 may have a leached region 133 and an unleached region 134. The leached region 133 may, after leaching, at least partially contain nanoparticles 210, or contain nanoparticles 210 in a region therein. Therefore, the leached region 133 may also mean a nanoparticle-containing region, without limitation. The leaching process may be controlled such that the leached material (e.g., metal-solvent catalyst, nanoparticles, metallic infiltrant, or combinations thereof) is removed from the upper surface 130, back surface 140, lateral surface 135, or combinations of any of the foregoing, inward to a depth L. Control of such leaching processes may include leach time, depth of immersion in leaching agent, leaching agent composition, leaching agent concentration, leaching temperature, leaching pressure, or combinations of any of the foregoing. For example, a PCD body may be completely immersed in a leaching agent for a short time, wherein the leaching agent only leaches inward a depth L into the PCD body from the upper, back, and lateral surfaces thereof. The resulting at least partially leached and infiltrated PCD body 132, depicted in FIG. 1K, may comprise an unleached region 134 being completely encompassed by a leached region 133. The depth L may be greater than about 10 μm, or a depth greater than about 50 μm, such as about 10 μm to about 1000 μm, about 50 μm to about 800 μm , about 200 μm to about 800 μm, about 400 μm to about 800 μm, about 250 μm to about 500 μm, such as about 10 μm to about 500 μm, about 20 μm to about 150 μm, about 30 μm to about 90 μm, about 20 μm to about 75 μm, about 200 μm to about 300 μm, or about 250 μm to about 500 μm.

In an embodiment, such as that depicted in FIG. 1L, a PCD body may be partially immersed in a leaching agent such that the PCD body is leached only at those surfaces immersed in the leaching agent. For example, the upper surface of the at least partially leached and infiltrated PCD body 132′ may be placed in a leaching vessel face down so that the upper surface 130 and a portion of the lateral surface 135 are exposed to the leaching agent therein, whereby a portion of lateral surface is not exposed to the leaching agent. The resulting leached region 133′ may extend inward a depth L from the upper surface and a portion of the lateral surface 135. The resulting at least partially leached PCD body may be at least partially infiltrated thereafter. The embodiments depicted in FIGS. 1K and 1L show a non-planar boundary between the leached region 133 and the unleached region 134; in embodiments the boundary may be substantially planar. The embodiments depicted in FIGS. 1K and 1L show a non-planar boundary between the leached region 133 and the unleached region 134, in embodiments, the boundary may be substantially planar. The embodiments depicted in FIGS. 1K and 1L show a leached region generally following the geometry of the surface of the PCD body (i.e., the leached region 133 is substantially parallel to the surface of the PCD body). In an embodiment, the leached region 133 or 133′ may be substantially parallel to an optional chamfer between the upper surface 130 and the lateral surface 135. In embodiments, the leached region may be substantially non-parallel to the PCD body. For example, as shown in FIG. 1M, the leached region 133″ may be formed at or near a corner of the PCD body 132″, such as between the upper surface 130 and the lateral surface 135 generally defined by a non-parallel boundary at an angle therebetween. In the above examples, the leached regions 133, 133′, and 133″ are depicted as encompassing the lateral surface 135 such that the leached region may be described as substantially annular, however, in other embodiments, the leached region may not extend around the entire periphery of the PCD body, but rather be broken or comprise a group of intermittent at least partially leached regions around the periphery of the PCD body. Any portion of leached region 133 may be at least partially or completely infused with nanoparticles. In an embodiment, the nanoparticles infiltrate/infuse into the at least partially leached PCD body in such a manner as to create a concentration gradient of the nanoparticles in which the portion of the at least partially leached PCD body near upper surface 130 is substantially completely filled with nanoparticles and the region nearer the back surface 140 is substantially completely empty of nanoparticles. In an embodiment, an at least partially leached and nanoparticle infiltrated PCD body may comprise a gradient of nanoparticles having no clearly defined nanoparticle-containing regions and non-nanoparticle-containing regions.

After leaching, the at least partially leached PCD body 124 may be substantially free of the catalyst material within at least a portion of interstitial spaces in at least one region of the at least partially leached PCD body 124. The empty interstitial spaces provide interconnectivity between adjacent interstitial spaces creating interconnected interstitial (porous) paths or pores (e.g., nanopores and/or micropores) and pore throats therebetween. The interconnected interstitial spaces or pores may create a relatively free path from one region of an at least partially leached PCD body 124 to another region of the at least partially leached PCD body 124. In an embodiment, the interstitial path from one region of a PCD body to another may be more or less tortuous based on one or more factors including, by way of non-liming example, average pore throat size in the path, the smallest pore throat size in the path, diamond powder and/or grain size, diamond grain shape, and nanoparticle size/shape. In an embodiment, the at least partially leached PCD body 124 may include one or more interconnected interstitial (porous) paths, being substantially free of catalyst material, wherein the interconnected interstitial (porous) path may extend from the upper surface 130 to at least an intermediate depth d. In an embodiment, the now empty or substantially empty interstitial spaces may be infiltrated/infused with another material, such as by way of non-limiting example, nanoparticles, metallic infiltrant, non-metallic infiltrant, catalyst, or combinations of the foregoing. In embodiments, such material may be infiltrated/infused into the PCD body 124 through such interstitial spaces and pore throats to a depth within the PCD body 124.

FIGS. 1E and 1F illustrate an embodiment of a PCD body 126 that has been at least partially leached and then infiltrated/infused with nanoparticles. In an embodiment, the at least partially leached PCD body 124 may be infiltrated/infused with nanoparticles by diffusing a fluid 215 having nanoparticles 210 suspended and/or dispersed therein through the empty or at least partially empty interconnected interstitial spaces therein, thereby carrying, infusing, distributing, or infiltrating the nanoparticles 210 into the at least partially leached PCD body 124. In an embodiment, and as explained in more detail below, the nanoparticles may infiltrate/infuse entirely or only to a certain depth within the PCD body 124 based on one or more of the following non-limiting factors including, nanoparticle size/shape, nanoparticle composition, average pore throat size (determined by a myriad of factors including, but not limited to, diamond average diamond particle or grain size, HPHT conditions, etc.), viscosity of the fluid suspending the nanoparticles, pressure applied to the PCD body by the fluid suspending the particles, and duration of application of nanoparticle bearing fluid. The nanoparticle containing region of the PCD body 126 may create a wall and/or a barrier into and/or past which no other infiltrant may infiltrate or which may limit infiltration into and/or past the nanoparticle containing region. Such a region having substantially no material in it with a coefficient of thermal expansion higher than that of bonded diamond grain may be relatively more thermally-stable than a region having an infiltrant with a coefficient of thermal expansion higher than that of bonded diamond grain (e.g., cobalt). Such a thermally-stable region may not need to be leached, or alternatively, may be partially or completely leached.

In an embodiment, the region containing nanoparticles may be at least partially leached. A region of a PCD body may be leached, infiltrated/infused with nanoparticles, and then at least partially leached to remove a portion of or all of the nanoparticles from a region of the nanoparticle-containing region. The rest of the PCD body or a portion of the PCD body may be protected from such leaching by control of leaching process conditions such as any of those described above, or may be protected by masking a portion thereof. Masking includes placing a protective coating over a portion of a PCD body in which the material therein is to be retained, such that the leaching agent does not penetrate into the portion of the PCD body behind the mask. Examples of methods of leaching using masks and masking techniques are described in U.S. Provisional Patent Application No. 61/728,953, and U.S. patent application Ser. No. 13/751,405, which are incorporated herein in their entirety by this reference.

In cross-sectional views of embodiments depicted in FIGS. 1E and 1F, the PCD body 126 may be at least partially infiltrated/infused with nanoparticles 210. In an embodiment, the nanoparticles 210 may diffuse through interconnected interstitial spaces and pore throats into the at least partially leached PCD body 124, thereby forming the at least partially infiltrated/infused PCD body 126. Referring to FIG. 1F, the nanoparticles 210 may diffuse or infuse through or into the interconnected interstitial (porous) spaces 165 having pore throats 170 therebetween, from the upper surface 130 generally toward the back surface 140, until the nanoparticles 210 become lodged (or otherwise stopped) in the at least partially leached PCD body 124 to occupy a desired region of the PCD body 124, or diffuse completely through the PCD body 124. In an embodiment, the nanoparticles 210 may diffuse into or through the interconnected interstitial (porous) spaces 165 and pore throats 170 therebetween, from the upper surface 130 generally toward the back surface 140 to an intermediate depth d. Nanoparticles may become stopped or otherwise not infiltrate/infuse deeper into a PCD body when they encounter a constriction or obstruction in the interconnected interstitial path (i.e., pore) or are no longer forced though the interconnected interstitial regions. In embodiments, the nanoparticles may become stopped in the PCD body by a diamond grain 121, a diamond-to-diamond bond 160, a pore throat 170, a nanoparticle 210 or group of nanoparticles 210, and/or sufficient pressure is no longer applied to the fluid suspending the nanoparticles 210 to diffuse the nanoparticle deeper into the PCD body 126, or combinations thereof. While FIG. 1F appears in a two-dimensional figure depicting many terminations or dead-ends between the interstitial spaces, such a two-dimensional cross-sectional view does not adequately demonstrate the three-dimensional nature of the PCD body and the additional interconnectivity of the interstitial (porous) paths that may exist in a three-dimensional model of such an embodiment.

While embodiments have been described wherein the nanoparticles are infiltrated/infused to an intermediate depth d, nanoparticles may infiltrate or infuse into the entire depth of a PCD body such as that depicted in FIG. 1O. While embodiments have been described wherein nanoparticles are infiltrated/infused to an intermediate depth d, the intermediate depth d may not be a sharply defined line or planar boundary, rather the intermediate depth d may be an irregular or substantially non-planar boundary at least partially defined by the pore throats, diamond-to-diamond bonds and/or bonded diamond grains 121 stopping the infiltration of nanoparticles into a portion or region of the PCD body. Such a substantially non-planar boundary may be said to define an average depth, which may also be referred to as the intermediate depth d. In an embodiment, the intermediate depth d may coincide with the leach depth L. For example, in FIG. 1P, the region containing nanoparticles may extend a depth d into the PCD body 126″ from the upper surface 130 and a portion of the lateral surface 135. The depth d may be at least partially limited/defined by the leach depth L. The region containing nanoparticles, depicted in FIG. 1P, may generally run parallel to the upper surface 130 and at least a portion of the lateral surface 135. The region containing nanoparticles may be substantially planar or non-planar. The unleached region, depicted nearer the back surface 140 in FIG. 1P may have interstitial spaces 165 that at least partially contain metal-solvent catalyst therein.

The intermediate depth d may extend a selected distance into a PCD body. In an embodiment, the intermediate depth d may extend at least about 50 μm into a PCD body, for example, at least about 100 μm, 200 μm, 500 μm, 1000 μm, or about 1200 μm into the PCD body from the upper surface thereof. In an embodiment, the intermediate depth d may extend about 50 μm to about 1000 μm, such as about 200 μm to about 800 μm, about 300 μm to about 700 μm, about 200 μm to about 500 μm, about 500 μm to about 700 μm, or about 700 μm to about 1000 μm into the PCD body from the upper surface thereof. In an embodiment, the intermediate depth d may be defined at least in part relative to the thickness of the PCD body. For example, the intermediate depth d may be about ninety percent (90%) or less of the thickness of the PCD body, about eighty percent (80%) of the thickness of the PCD body, about seventy-five percent (75%) of the thickness of the PCD body, about fifty (50%) percent of the thickness of the PCD body, about twenty-five (25%) percent of the thickness of the PCD body, or about ten percent (10%) of the thickness of the PCD body.

In an embodiment, the least partially leached and at least partially nanoparticle infiltrated/infused PCD body 126 may be bonded to a substrate 150 after nanoparticle infiltration. FIG. 1G is an embodiment of the at least partially leached and nanoparticle infiltrated/infused PCD body bonded to the substrate 150, to form a bonded and infiltrated PCD body 128. In an embodiment, bonding the at least partially leached and nanoparticle infiltrated PCD body 126 to the substrate 150 includes subjecting the PCD body 126 and the substrate 150 to a second HPHT process, substantially similar to the first HPHT described above, such as the same or similar HPHT parameters. In an embodiment, the second HPHT process may be carried out at temperatures and/or pressures below that of the first HPHT process. In an embodiment, the substrate 150 and the at least partially leached and nanoparticle infiltrated PCD body 126 may be placed in a pressure transmitting medium as described above, wherein the interfacial surface 145 of the substrate and the back surface 140 of the PCD body 126 are positioned adjacent to one another. The pressure transmitting medium, including the at least partially leached and nanoparticle infiltrated PCD body 126 and substrate 150, may be subjected to a second HPHT process using an HPHT press at a temperature of at least about 700° C. (e.g., about 1000° C. to about 1600° C.) and a cell pressure of at least 4 GPa (e.g., about 5 GPa to about 10 GPa, about 7 GPa to about 9 GPa) for a time sufficient to form a bond between the PCD body/body 126 and the substrate 150 substantially as shown in FIG. 1G. In an embodiment, the PCD body may be bonded to the substrate 150 by a constituent infiltrant from the substrate 150 (e.g., cobalt from a cobalt-cemented tungsten carbide substrate), which may melt and sweep through the interstitial regions of the PCD body 126 from the back surface 140 thereof, thereby bonding the PCD body 126 and substrate 150 together upon cooling of the constituent infiltrant within the interstitial spaces of the PCD body to form the bonded and infiltrated PCD body 128. In an embodiment, the bonded and infiltrated PCD body 128 may include the region containing constituent infiltrant 129 adjacent to the back surface 140 and the nanoparticle containing region 127 adjacent to the upper surface 130. In an embodiment, the bonded and infiltrated PCD body 128 may include more than one constituent infiltrant therein. In an embodiment, the constituent infiltrant may comprise iron, cobalt, nickel, carbides, nitrides, non-refractive metals from the carbides or nitrides, or combinations of the foregoing. For example, in an embodiment, the substrate may comprise cobalt cemented tungsten carbide and, during the second HPHT process, the cobalt may at least partially melt and sweep into the empty interstitial regions of at least a portion of the at least partially leached and infiltrated PCD body 126 from the back surface 140 thereof, creating the region containing the constituent infiltrant 129. The cobalt may also carry some of the tungsten and/or some of the carbide into the PCD body from the back surface 140 thereof. The cobalt and/or tungsten and carbide may then cool and solidify in the interstitial regions of the PCD body, resulting in a bond between the substrate 150 and the bonded and infiltrated PCD body 128.

In an embodiment, the constituent infiltrant may only infiltrate/infuse as far into the PCD body as the interstitial regions remain unoccupied. Accordingly, in an embodiment, nanoparticle being present may define a depth of nanoparticle-containing region 127 into which the constituent infiltrant may not extend or in which infiltration into the nanoparticle-containing region 127 is limited. In an embodiment, the nanoparticle-containing region 127 extends to the depth d and some of the interstitial spaces or substantially all of the interstitial spaces are filled with nanoparticles. Infiltration of the constituent infiltrant may not progress into the nanoparticle-containing region 127 or may be limited by the region 127 so that any infiltration of the constituent infiltrant is less than if the nanoparticles where not present. In an embodiment, the constituent infiltrant may be present in both regions 127 and 129. The amount of constituent infiltrant in the nanoparticle-containing region 127 may be less than that present in the constituent infiltrant region 129 before optional leaching of the PCD body. For example, the constituent infiltrant may comprise more than about 6 wt % of the region 129, such as about 6 wt % to about 8 wt % of the region 129. The constituent infiltrant may comprise less than about 5 wt % of the nanoparticle-containing region 127. For example, the constituent infiltrant may comprise about 4 to 5 wt %, about 3-5 wt %, about 2-3 wt %, or less than about 3 wt % of the nanoparticle-containing region 127. In an embodiment, a braze material may be placed between the PCD body 126 and the substrate 150, which are all placed in a pressure transmitting medium substantially as described above, the pressure transmitting medium may be brought to a pressure and temperature sufficient to melt the braze material which may then sweep into the PCD body and the substrate 150, thereby bonding the two together. In other embodiments, the brazing may not be conducted under HPHT conditions. For example, vacuum brazing may be used to bond the substrate 150 to PCD body.

FIG. 1H is an embodiment of an at least partially leached and nanoparticle infiltrated PCD body 126′ wherein the nanoparticle infiltration extends within the depth d″ of the PCD body 126′. Explaining further, the nanoparticle-containing region 127 is positioned between an upper intermediate depth d′ and lower intermediate depth d′″. The upper intermediate depth d′ and lower intermediate depth d′″ may include similar or the same depths and ranges as those disclosed regarding depth d discussed above. For example, in an embodiment, the intermediate depth d″ may be about 200 μm. In an embodiment, the at least partially leached and nanoparticle infiltrated PCD body 126′ may include the nanoparticle-containing region 127 surrounded by at least partially leached regions 125 (having little to substantially no nanoparticle infiltrant disposed therein) on either side. In an embodiment, the at least partially leached region 125 nearer the upper surface may be referred to as the upper region.

FIG. 1I is an embodiment of a PDC 100′ comprising an at least partially leached and nanoparticle containing PCD body 126′ bonded to a substrate 150. In an embodiment, the at least partially leached and nanoparticle infiltrated PCD body 126′ may be bonded to the substrate 150 in a manner substantially similar to any described herein, including those above regarding the PDC depicted in FIG. 1G. The resulting bonded and infiltrated PCD body 128′ may include the leached region 125 nearest the upper surface 130, or upper region, having substantially all of the interstitial spaces therein free from nanoparticles and/or catalyst material, the constituent infiltrant infiltrated region 129 nearest the back surface 140 having constituent infiltrant from the bonding process therein, and the nanoparticle-containing region 127 disposed between the regions 129 and 125. Such a nanoparticle-containing region 127 may have substantially only nanoparticles disposed in the interstitial spaces therein, or may have constituent infiltrant and nanoparticles disposed therein, but less constituent infiltrant by proportion than in region 129. In an embodiment, the leached region 125 may also have a second infiltrant material therein, the second infiltrant material may be the same as or different from the nanoparticles 210, and may also be provided in the form of nanoparticles (e.g., from a powder). Suitable second infiltrants for the leached region 125 at or near the upper surface 130 may include materials formulated to improve the thermal and or mechanical properties of the PCD body including, by way of non-limiting example, one or more of ultra-dispersed diamond (“UDD”) particles, copper, silicon, or silicone. As used herein, “ultra-dispersed diamond particles” or “UDD particles,” also commonly referred to in the art as nanocrystalline diamond particles, means particles each comprising a polycrystalline diamond core surrounded by a metastable carbon shell. Such ultra-dispersed diamond particles may exhibit a particle size of about 1 nm to about 50 nm and more typically, of about 2 nm to about 20 nm, and agglomerates of ultra-dispersed diamond particles may be between about 2 nm to about 200 nm. The leached region 125 may be infiltrated with a second infiltrant separately or simultaneously with the constituent infiltrant infiltration of region 129 during the second HPHT process. Any of regions 125, 127, 129, or combinations thereof may be leached after boding to the substrate 150.

In an embodiment, a bonded and infiltrated PCD body 128″ may be leached subsequent to bonding with the substrate 150. For example, FIG. 1N depicts a PDC 100″ comprising a PCD body 128″ that has been infiltrated/infused with nanoparticles and bonded to the substrate 150. The PCD body 128″ may then be leached to remove at least a portion of the constituent infiltrant and/or nanoparticles therefrom. As depicted in FIG. 1N, the PCD body 128″ may have a region 127 that contains nanoparticles, a region 129 containing constituent infiltrant, and an at least partially leached region 125. The region 129 may have, after infiltration/infusion but before bonding to a substrate, contained substantially no nanoparticles therein and/or no constituent infiltrant therein. During bonding, a constituent infiltrant may infiltrate or sweep into the PCD body from the back surface 135 thereof to form a region 129 containing constituent infiltrant. The constituent infiltrant may be substantially stopped, blocked, or at least partially stopped or blocked from infiltrating further into the PCD body (i.e., into regions 125 and 127) by the nanoparticles in nanoparticle-containing region 127. In an embodiment, the constituent infiltrant may infiltrate into or through the nanoparticle-containing region 127, and possibly into the at least partially leached region 125. However, the constituent infiltrant in such a region will be present in a lesser concentration than portions of the PCD body that do not contain nanoparticles therein or are not disposed on the opposite side of the nanoparticle-containing region from the substrate. Optionally, a peripherally extending chamfer 137 may formed on the PCD body between the upper surface 130 and the lateral surface 135 before or after bonding, according to any of the techniques discussed above. In an embodiment, both of the regions 125 and 127 may contain nanoparticles therein after infiltration/infusion. The PCD body may be at least partially leached to remove at least a portion of the nanoparticles and/or constituent infiltrant therefrom, thereby forming an at least partially leached region 125.

FIG. 1N depicts an embodiment wherein the nanoparticles have been leached from a discrete region of the bonded and infiltrated PCD body 128″ to form a nanoparticle-containing region 127 and an at least partially leached region 125. The leached region 125 may be formed by limiting the effects of leaching to only a portion or region of the bonded and infiltrated PCD body in substantially the same manner as any of the leaching techniques discussed herein. For example, a bonded and infiltrated PCD body and corresponding substrate may be partially disposed in or exposed to leaching agent to remove nanoparticles from at least a portion or region thereof. In an embodiment, leaching the nanoparticles from at least a portion of region of an infiltrated and bonded PCD body may be accomplished by exposing only that portion or region to the leaching agent, such as by partial immersion or masking techniques as discussed above. The resulting bonded and infiltrated PCD body 128″ may include an at least partially leached region 125, a nanoparticle-containing region 127, and a constituent infiltrant containing region 129. Such a region 127 may be positioned substantially proximate to a radially outermost portion of upper surface 130 and substantially proximate to the chamfer 137. As shown, the geometry of the at least partially leached region 125 may correspond to the exterior surface geometry of the bonded and infiltrated PCD body 128″, for example, by generally running parallel to a chamfer 137 between the upper surface 130 and the lateral surface 135.

A residual amount of constituent infiltrant (e.g., cobalt from a cobalt-cemented tugnsten carbide substrate) may remain in each of the regions of the at least partially leached PCD table after leaching. Accordingly, at least a residual amount of metal-solvent catalyst (e.g., about less than 2 wt %, about 1 to about 2 wt %, or about 0.5 to about 0.85 wt %) may remain in one or more of the at least partially leached region 125, the nanoparticle-containing region 127, or the constituent infiltrant containing region 129 after bonding and/or nanoparticle infiltration. As noted above, in some embodiments, the nanoparticle-containing region 127 may only limit or partially block constituent infiltrant from infiltrating into the nanoparticle-containing region 127 and beyond into the at least partially leached region 125 during the second high pressure/high temperature process. Such a PCD body may comprise less constituent infiltrant in the at least partially leached region 125 than in the nanoparticle-containing region 127, and the constituent infiltrant containing region 129. Therefore, in embodiments, the nanoparticle-containing region 127 and/or the at least partially leached region 125 may be subsequently leached of constituent infiltrant present in those regions after bonding (i.e., after the second HPHT process). Infiltrated PCD bodies, according to any embodiment, may be subsequently leached after infiltration with nanoparticles (e.g., before or after bonding with a substrate). Optionally, nanoparticles may be at least partially removed by such leaching, without limitation. By way of non-limiting example, region 125 in FIG. 1N may have contained nanoparticles therein, wherein a leaching process renders region 125 substantially free of nanoparticles.

In an embodiment, the nanoparticles infiltrate/infuse into the at least partially leached PCD body 124 in such a manner as to create a concentration gradient of the nanoparticles in which the portion of the at least partially leached PCD body 124 near upper surface 130 is substantially completely filled with nanoparticles and the region nearer the back surface 140 is substantially completely empty of nanoparticles. In an embodiment depicted in FIG. 1J, an at least partially leached and nanoparticle infiltrated PCD body 126″ may comprise a gradient of nanoparticles having no clearly defined nanoparticle-containing regions and nanoparticle free regions. In an embodiment, the at least partially leached and infiltrated PCD body 126″ may be joined to a substrate substantially as described above regarding any of the PCD bodies disclosed herein. The bonded PCD body having a gradient of nanoparticles therein may exhibit more constituent infiltrant nearer the back surface 140 than at a point farther from the back surface 140, corresponding to the gradient/amount of nanoparticles therein. A gradient of nanoparticles in a PCD body may result in a beneficial residual stress gradient therein and thereby more resistance to fracture.

In an embodiment, a chamfer 137, substantially as depicted in FIG. 1A may be formed on the PCD body between the upper surface 130 and at least one lateral surface 135 after the PCD body is bonded to the substrate. A chamfer may be machined into the PCD body using one or more of grinding, lapping, and electro-discharge machining (“EDM”). In an embodiment, a chamfer may be machined into the PCD body before the PCD body is bonded to the substrate. For example, in an embodiment, a PCD body may be formed and leached, and then before infiltration with nanoparticles may be machined to include a chamfer, and subsequently be bonded to a substrate. In such an embodiment, the intermediate depth d and/or upper intermediate depth d′ may substantially follow the geometry of the chamfer from the outside of the PCD body inward (i.e., the depth d or intermediate depth d′ may be substantially parallel to the surface of the PCD body or table). In an embodiment, a PCD body may be formed, leached, infiltrated/infused with nanoparticles and then machined to include a peripherally extending edge chamfer about the upper surface thereof; the PCD body may then be bonded to a substrate.

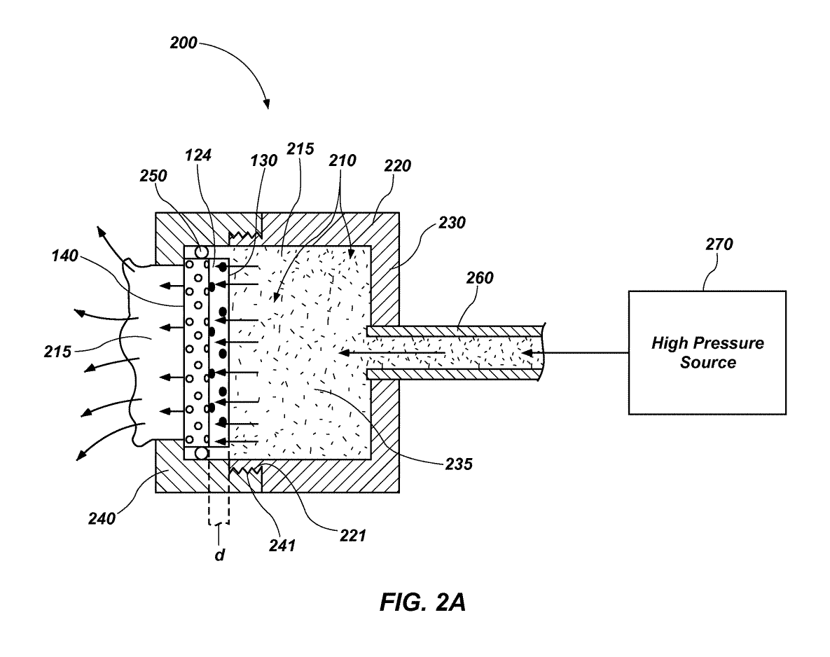

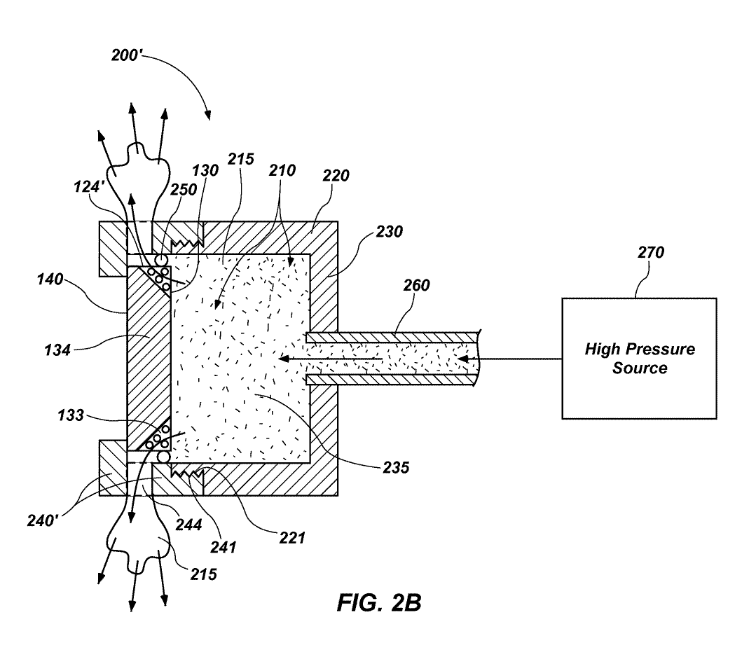

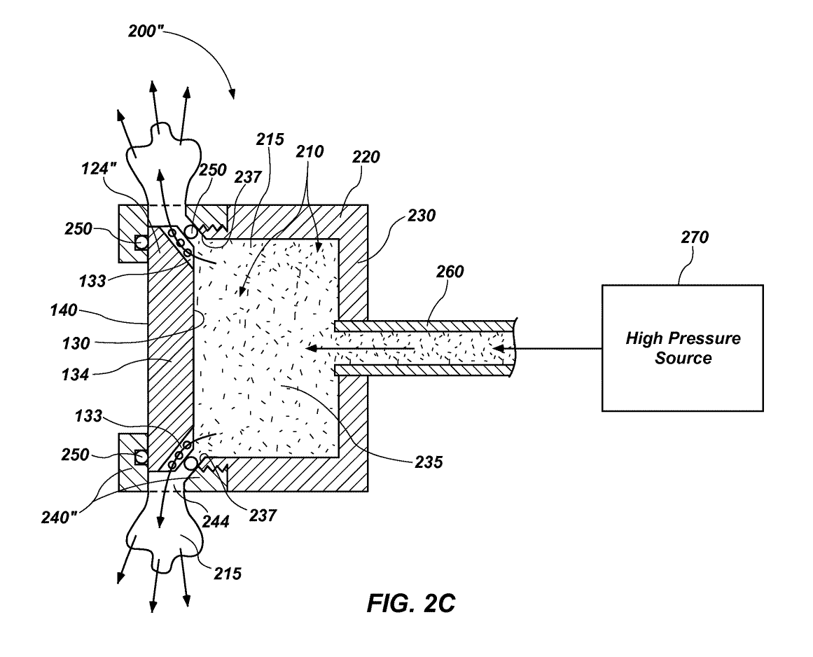

FIG. 2A depicts an apparatus for infiltrating a PCD body with nanoparticles according to an embodiment. In an embodiment, the infiltrating apparatus 200 may include at least one side wall 220 connected to a base wall 230. In an embodiment, the partially leached PCD body 124 may be positioned in the infiltration apparatus 200 on the at least one sidewall 220, and then be infiltrated/infused with nanoparticles. In embodiments, placing the at least partially leached PCD body in the infiltration apparatus 200 may substantially seal the interior volume 235 of the infiltration apparatus 200 from the environment outside of the infiltration apparatus, whereby the infiltration apparatus having a PCD body 124 disposed therein may effectively contain elevated pressures. In an embodiment, the at least one side wall 220 and/or base wall 230 may be further connected to an inlet 260 configured to deliver pressure and/or nanoparticle-containing fluid to the apparatus 200. In an embodiment, the at least one side wall 220 may be connected to a retaining ring 240 generally opposite the base wall 230. In an embodiment the retaining ring 240 may be attached to the sidewall 220 using one or more of complementary threading 241 and 221 therebetween, mechanical fasteners, and adhesives. The at least partially leached PCD body 124 may be positioned in the infiltration apparatus 200 with the upper surface 130 being disposed toward an interior volume 235 of the infiltration apparatus 200. The at least partially leached PCD body 124 may further be positioned with the back surface 140 exposed to the environment outside of the infiltration apparatus 200. In an embodiment, the PCD body 124 may be disposed in the retaining ring 240, optionally with a sealing element 250, which may include, by way of non-limiting example, a gasket, an O-ring, a washer, a clip, a lip, or a spring. In an embodiment, the retaining ring 240, and optionally the sealing element may 250, may be configured such that the PCD body 124 positioned therein substantially seals the interior volume 235 from the environment outside of the interior volume, and will not move or become dislodged during infiltration/infusion.

In an embodiment, the interior volume 235 may include the fluid 215 and nanoparticles 210. In an embodiment, pressure may be applied to the interior volume, whereby the fluid 215 having the nanoparticles 210 suspended therein may be diffused through the interstitial regions of the at least partially leached PCD body 124. In an embodiment, pressure may be applied to the interior volume 235 and thereby to the fluid 215, whereby the fluid 215 having the nanoparticles 210 suspended therein may be diffused through the interconnected interstitial spaces of the at least partially leached PCD body 124 positioned therein from the upper surface 130 generally toward the back surface 140. In an embodiment, pressure may be applied to the fluid 215 in the interior volume 235 via a pressure source 270 in communication with the inlet 260. In an embodiment, the pressure source 270 may include a high-pressure pump. In an embodiment, the fluid 215 and the nanoparticles 210 may be pumped into the interior volume by the pressure source 270, thereby providing increased pressure to the interior volume 235. In an embodiment the pressure applied to the fluid 215 having nanoparticles 210 therein may be a pressure slightly above ambient pressure for example, above about 0.102 MPa, above about 20 MPa, above about 50 MPa, above about 100 MPa, above about 200 MPa, above about 350 MPa, or above about 500 MPa. In an embodiment, the suitable pressure range for infiltration/infusion may include about 0.102 MPa to about 500 MPa, for example, about 50 MPa to about 400 MPa, or about 100 MPa to about 350 MPa. The pressure exerted on the fluid may be elevated before and/or the nanoparticles have been suspended therein.

In an embodiment, the fluid 215 may travel through the interconnected interstitial spaces 165 of the at least partially leached PCD body 124, from the upper surface 130 to the back surface 140, carrying the nanoparticles 210 through the PCD body 124, thereby infiltrating/infusing substantially the entire PCD body 124 with nanoparticles 210. In an embodiment depicted in FIG. 2A, the fluid 215 may travel all the way through the interconnected interstitial spaces 165 of the at least partially leached PCD body 124, from the upper surface 130 to the back surface 140, carrying the nanoparticles 210 only part of the way through the PCD body 124, thereby infiltrating/infusing only a portion of the PCD body 124 with nanoparticles 210 to a depth d or within a selected region. In an embodiment, the depth d or selected region may be at least partially determined by one or more criteria including, but not limited to, leach depth, amount and uniformity of nanoparticles suspended in the fluid, average pore throat size in interconnected interstitial spaces, the average nanoparticle size, average diamond grain size, fluid density, fluid viscosity, or amount of pressure applied to the fluid. In an embodiment, any of the above criteria may be adjusted to achieve the desired infiltration region or depth.

In embodiments, the orientation of the PCD body and the infiltration apparatus 200 may vary. For example, in an embodiment, the infiltration apparatus 200 may be positioned vertically such that the PCD body 124 therein is on the bottom of the infiltration apparatus 200, and gravity may assist in infiltration/infusion of nanoparticles therein. Further, a vertical configuration may have the added benefit of aiding in even/uniform distribution of nanoparticles along the entire area of the PCD body 124.

During infiltration/infusion it may be necessary to support the PCD body 124 against the bending stresses exerted by the pressure of the applied fluid on the PCD body. The retaining ring may be configured to support the PCD body across the entire back surface 140 or substantially the entire back surface 140 thereof. For example, the retaining ring may extend from the lateral surface 135 of the PCD body 124 across the entire back surface 140 of the PCD body 124. In order to maintain flow, such a retaining ring, may be configured to allow for fluid to travel therethrough. In an embodiment, a retaining ring may include vent holes cut therein. The vent holes may be provided in a number or pattern therein to achieve the desired amount of flow of fluid and nanoparticles through the PCD body 124 supported therein. For example, a retaining ring that extends substantially across the entire back surface 140 of a PCD body 124 may have hundreds of vent holes or less therein, the vent holes may have any number of differing sizes, for example more than about 1 nm, such as about 5 nm to about 50,000 μm. In an embodiment, the retaining ring may comprise a high permeability ceramic, having no vent holes cut therein. In an embodiment, an infiltration apparatus 200 may include a retaining ring comprising vent holes therein in and a high permeability ceramic disposed between the retaining ring and the PCD body 124, whereby the high permeability ceramic supports the PCD body, and allows flow of fluid and nanoparticles therethrough.

FIG. 2B depicts an embodiment of an infiltration apparatus 200′ in which nanoparticles are infiltrated/infused into a portion thereof. The infiltration apparatus 200′ is substantially similar to infiltration apparatus 200. In an embodiment, substantially as depicted in FIG. 2B, the retaining ring 240′ may be configured such that a plurality of vent holes 244 are formed about the periphery thereof, wherein the plurality of vent holes 244 may allow flow of fluid 215 through at least a single region of the PCD body 124′, thereby facilitating infiltration/infusion of nanoparticles into the at least a single region of the PCD body. For example, the at least partially leached PCD body 124′ having an unleached region 134 and a leached region 133 may be positioned in the infiltration apparatus 200′ in the retaining ring 240′, optionally with the aid of a retaining aid 250 substantially as described above. The at least partially leached PCD body 124′ may at least partially create an interior volume 235 in the infiltration apparatus substantially as described above regarding infiltration apparatus 200. The leached region 133 of the PCD may allow flow or infusion of fluid and nanoparticles through and into the interstitial spaces therein, while the unleached region 134 may substantially block the flow/infiltration of fluid and nanoparticles therethrough. The PCD body 124′ may be infiltrated/infused with nanoparticles 210 by diffusing or infusing nanoparticles 210 suspended in fluid 215 into the leached region 133 wherein the nanoparticles may become lodged or stopped substantially as described above. The resulting PCD body may resemble, as non-limiting examples, PCD body 132, 132′, or 132″ as substantially as depicted in FIGS. 1K-1M. Specifically, the PCD body 124′, as shown in FIG. 2B, may have an unleached region 134 and a leached region 133 wherein nanoparticles are infiltrated/infused into at least a portion of the leached region 133, thereby forming the at least partially infiltrated PCD body 132″.

The plurality of vent holes 244 on the retaining ring 240′ may be radially distributed thereon. The plurality of vent holes 244 may include two or more vent holes, such as more than vent 10 holes, between 2 and 20 vent holes, between 4 and 10 vent holes, 6 holes, or 8 vent holes. The plurality of holes 244 may exhibit any number of vent hole sizes, for example, an individual vent hole be about more than about 0.01 inches wide, more than about 0.02 inches wide, such as about 0.05 inches wide, or about 0.1 inches wide, between about 0.02 inches and about 0.3 inches wide. Vent hole width as discussed herein is intended to refer to the size of the vent hole at its widest, which may be at the outer periphery of the retaining ring. A retaining ring 240′ having a plurality of vent holes therein may exhibit a uniform vent hole size. In another embodiment, the plurality of vent holes 244 may exhibit one or more vent hole size. The vent holes 244 may be spaced at even intervals radially about the periphery of the retaining ring 240′. In an embodiment, the vent holes 244 may be in sufficient number and width to allow flow/infiltration of nanoparticles through a substantially continuous region of the PCD body, such as the entire upper surface 130, or a region about the periphery of the PCD body, thereby creating a substantially continuous infiltrated region therein. The substantially continuous infiltrated region may be disposed at least about the periphery of the PCD body, or at least at a side surface of the PCD body. In an embodiment, the vent holes 244 may be spaced apart to create an intermittent pattern of gaps between infiltrated regions in the PCD body. In an embodiment, vent holes 244 may be spaced in an in an even or uneven pattern about the retaining ring 240′. By way of non-limiting example, a group of vent holes 244 may be placed radially opposite a single vent hole in a retaining ring 240.′

FIG. 2C depicts an embodiment of an infiltration apparatus 200″ in which a chamfered PCD body 124″ may be positioned. Infiltration apparatus 200′ is substantially similar to infiltration apparatus 200″. As depicted in FIG. 2C, the at least one side wall 220 may have an inner chamfer 237 formed therein, wherein the inner chamfer 237 may correspond to a chamfer 137 on a PCD body 124″ whereby an interior volume is at least partially created and defined by the PCD body 124″ being positioned in the retaining ring 240″. The retaining ring 240″ may include any of those feature describe above, including for example, the plurality of vent holes 244. In an embodiment, a retaining aid 250 may be positioned between the chamfer 137 of the PCD body 124″ and the inner chamfer 237 to seal the infiltration apparatus thereby at least partially forming an interior volume 235. A fluid 215 having nanoparticles 210 suspended therein may be diffused through or infused into the empty interstitial spaces of the at least partially leached region 133 in the PCD body 124″ in substantially the same manner as any of the acts describe above. The resulting at least partially leached and infiltrated PCD body may have a region containing nanoparticles extending inward from and substantially parallel to the surface of the PCD, including any chamfer 137. The retaining ring 240″ may include an optional retaining aid contacting the back surface 140 of the PCD body 124″. The infiltration apparatuses 200′ and 200″ may not be limited to infiltration/infusion of only partially leached PCD bodies, but may also be used with a PCD body that has been substantially entirely leached, such as that depicted in FIG. 1D. Infiltration/infusion of nanoparticles into a PCD body may be carried out upon any of the at least partially leached PCD bodies herein using any of the infiltration apparatuses, materials, techniques, or combinations of the foregoing described herein, further, the resulting at least partially leached and infiltrated PCD bodies may be formed having any geometry, region, composition or combination of the foregoing described herein.

In embodiments, nanoparticles suitable for infiltration/infusion into the at least partially leached PCD body 124 may include non-solvent materials. At elevated temperatures, materials generally non-catalytic relative to diamond do not promote chemical breakdown or back-conversion of the diamond grains to graphite, carbon monoxide, carbon dioxide, or combinations thereof, which results in degradation of the mechanical properties of the PCD body. Non-solvent nanoparticles may include, by way of non-limiting example, nanodiamond particles (e.g., ultra-dispersed diamond particles), refractory metals, metalloids, metal oxides, metal carbides, metal nitrides, glass, or combinations of the foregoing.

Suitable glasses for the nanoparticles may include, but are not limited to, a silicate glass, a borate glass, a phosphate glass, a borosilicate glass, or combinations of any of the foregoing glasses. For example, the nanoparticles may comprise sodium silicate, zirconium silicate, lithium silicate, sodium borosilicate, zirconium borosilicate, lithium borosilicate, lithium aluminosilicate, or combinations thereof. In some embodiments, any of the foregoing glasses may be reinforced with a filler made from ceramic particles. For example, the ceramic particles may include, but are not limited to, boron nitride particles, titanium diboride particles, zirconium oxide particles, and combinations of the foregoing ceramic particles.

Suitable metals used in metal oxide, metal carbide, or metal nitride nanoparticle infiltrants may include refractory metals, including, but not limited to, one or more of titanium, vanadium, chromium, molybdenum, and tungsten. In an embodiment, metal oxide nanoparticles may include aluminum oxide or zirconium oxide. In an embodiment, a metal nitride nanoparticles may include, by way of non-limiting example, zirconium nitride, tungsten nitride, vanadium nitride, tantalum nitride, or niobium nitride. In another embodiment, a suitable nanoparticles may include boron nitride or silicon nitride. In an embodiment, a metal carbide may comprise an interstitial carbide including, but not limited to, titanium carbide, tungsten carbide, zirconium carbide, and molybdenum carbide. In an embodiment, suitable nanoparticles may comprise one or more different materials.

In an embodiment, the non-solvent material may be selected based on at least the coefficient of thermal expansion of said material. Materials having a higher coefficient of thermal expansion than diamond tend to cause breaking, spalling, and cracking of PCD bodies when exposed to elevated temperatures. For example, a PCD body having cobalt disposed in interstitial regions therein will degrade over about 700° C. because the coefficient of thermal expansion for cobalt is higher than that of diamond which causes the cobalt to expand inside of the PCD body thereby causing stress and breakage from the inside of the PCD body. By providing a nanoparticles that exhibit a negative or even a small positive coefficient of thermal expansion, thermal stresses and/or thermal damage (e.g., breaking diamond-to-diamond bonds) may be reduced as the temperature of the PCD body increases during use (e.g., during cutting a subterranean formation during drilling) as compared to when the material in the interstitial region has a much larger coefficient of thermal expansion, such as a metal-solvent catalyst like cobalt. In an embodiment, an nanoparticle material with a coefficient of thermal expansion less than or closely matching that of diamond, or at least less than the solvent-metal catalyst used to form the PCD is selected to infiltrate/infuse into the PCD body. Suitable material having a coefficient of thermal expansion closely matching that of the PCD body or at least less than that of the solvent-metal catalyst used to form the PCD body may include UDD particles, silicon, silicone, or combinations thereof.

In an embodiment, a nanoparticle material having a negative coefficient of thermal expansion is used to infiltrate the PCD body. Materials having a negative coefficient of thermal expansion include, by way of non-limiting example, zirconium tungstates particles, beta spodumene particles, beta eucryptite particles, or combinations thereof.

In embodiments, nanoparticles suitable for infiltration may be selected based at least partially on average nanoparticle size. In embodiments, suitable nanoparticles may exhibit an average size smaller than about: 20 μm, 5 μm, 1 μm, 500 nm, 200 nm, 100 nm, 50 nm, 25 nm, 15 nm, 10 nm 5, nm, 2 nm, 1 nm, or 500 μm. In embodiments, suitable nanoparticles may exhibit an average size of about 5 nm to about 800 nm, about 200 nm to about 900 nm, or about 100 nm to about 500 nm. In an embodiment, more than one size and/or type of nanoparticle may be used. In an embodiment, the nanoparticle infiltrants may include a portion exhibiting a relatively larger average nanoparticle size between about 5 μm and about 1 μm and another portion exhibiting a relatively smaller average nanoparticle size between about 500 nm and 1 nm. In some embodiments, the nanoparticles may comprise three or more different average nanoparticle sizes (e.g., one relatively larger average nanoparticle size and two or more relatively smaller average particle sizes), without limitation.

In an embodiment, nanoparticles 210 may be disposed in, suspended in, dispersed in, combinations thereof, or otherwise carried in the fluid 215. In an embodiment, the fluid 215 comprising nanoparticles may be diffused through the at least partially leached PCD body 124 to form the infiltrated PCD body 126. Suitable fluids may include, by way of non-limiting example, fluids that will not react with the PCD body, fluids that will not react with the nanoparticles, fluids with density sufficient to suspend nanoparticles, fluids that with viscosity sufficient to allow the fluid to diffuse through the empty interstitial regions in a PCD body, fluids that may dry or otherwise evaporate readily upon heating, and/or combinations of one or more of the foregoing. In an embodiment, the fluid may comprise one or more of water and organic solvents, including polar and non-polar solvents. Suitable organic solvents may include one or more of alcohol, dichloromethane (DCM), tetrahydrofuran (THF), dimethyl sufloxide (DMSO), pentane, hexane, chloroform, carbon tetrachloride, and/or combinations of one or more of the foregoing. In an embodiment, the fluid may comprise a surfactant. In an embodiment, a fluid may be selected/used to infiltrate or diffuse through a PDC body based at least on fluid density and/or viscosity. Fluids, as discussed herein, may be a liquid or a gas.

In an embodiment, the nanoparticles 210 may be suspended and/or dispersed in the fluid 215 by mixing into the fluid while stirring or otherwise agitating the fluid to create a substantially uniform distribution of the nanoparticles 210 within the fluid 215. In an embodiment, the nanoparticles 210 may be suspended in only a portion of the fluid 215 diffused through a PCD body 124. In an embodiment, nanoparticles may be supplied to the fluid during only a portion of the duration in which a fluid is diffused into the PCD body 124. For example, nanoparticles 210 may be added to or otherwise disposed in a fluid 215 for a short time during infiltration wherein the nanoparticles are diffused a distance through or into a selected region of the PCD body from the upper surface 130 toward the back surface 140 until they are stopped according to any manner disclosed above, whereby the resulting PCD body may resemble at least partially leached and infiltrated PCD body 126′, 126″, 132, 132′, or 132″ depicted in FIGS. 1H and 1J-1M. In an embodiment, the nanoparticles 210 may be introduced and mixed into the fluid at the pressure source 270. In an embodiment, the nanoparticles may be introduced and/or mixed into the fluid in the interior volume 235. In an embodiment, nanoparticles 210 may be disposed in the fluid 215 wherein the fluid 215 is subject to elevated pressure sufficient to force the nanoparticles 210 into the interstitial regions of a partially leached PCD body 124 in such a way as to create a gradient of nanoparticles therein substantially resembling that of PCD body 126″ depicted in FIG. 1J. Such an embodiment may include elevating the pressure exerted on the fluid having nanoparticles therein, and then lowering the pressure to some pressure above ambient but insufficient to force nanoparticles as deep into the body as the highest elevated pressure used in the process. In an embodiment, applying pressure to the fluid 215 containing nanoparticles 210 may be combined with selecting and using a specific type and/or size of nanoparticle and/or diamond powder to achieve the desired amount of nanoparticles throughout the infiltrated PCD body. In another embodiment, infusion may be carried out using a fluid or a gas, for example, using discrete bursts or application of pressurized gas carrying nanoparticles therein to diffuse or infuse the nanoparticles through or into the interconnected pore spaces of the PCD body to a desired depth d or selected region. In another embodiment, ultrasonic agitation/vibration may be used to diffuse/infuse nanoparticles into a PCD body. For example, a selected amount of nanoparticles may be disposed on a surface of a PCD body, the PCD body and the nanoparticles may be subjected to ultrasonic agitation until the particles diffuse/infuse into the PCD body to a desired depth or into selected region therein. Discrete bursts or durations of application of ultrasonic agitation may at least partially determine the depth that the nanoparticles diffuse/infuse to. Additionally, the size, shape, composition, and/or amount of the nanoparticles used may at least partially determine the depth d or region having a depth d″ in the resulting PCD body.

In an embodiment, a gradient of diamond particles may be selected to create a gradient of sintered diamond grains after the first HPHT process in which the gradient of diamond grains may allow for infiltration/infusion of nanoparticles in a gradient such as that depicted in FIG. 1J. For example, a layer of diamond powder exhibiting an average particle size of about 40 μm may be placed on a layer of diamond powder exhibiting an average particle size of about 30 μm, which may be placed on a layer of diamond powder exhibiting an average particle size of about 20 μm, the layers may have metal-solvent catalyst therein or adjacent thereto substantially as described above. After sintering, the resulting PCD body may exhibit a layered or gradient appearance of bonded diamond grains. After leaching metal-solvent catalyst therefrom, the layered/gradient PCD body may be infiltrated/infused with nanoparticles whereby the nanoparticles may infiltrated/infused into the larger interstitial spaces between larger diamond grains more easily than the interstitial spaces between the smaller diamond grains, which may result in better infiltration/infusion in the layers or portion of the gradient having larger diamond grains, and less infiltration in the layers or portion of the gradient having smaller diamond grains therein. The resulting infiltrated PCD body may resemble the infiltrated PCD body 126″. In embodiments, any number of layers may be used to form a gradient, and any combination of diamond powder particle size may be used to create the layers or gradient. Accordingly, a nanoparticle infiltrant or infiltrant size may be selected based upon the average particle and/or grain size of the PCD table or layer therein.

In an embodiment, the average diamond particle size may be selected based on the desired average pore throat size. In an embodiment, average pore throat size may be selected based on the desired nanoparticle size or composition. Nanoparticle size may be selected based on the desired nanoparticle infiltration depth for a given PCD body. In an embodiment, nanoparticle size may be selected based on average pore throat size, for example, nanoparticles 210 having a size closely matching that of the average pore throat size with travel through a PCD body more slowly and become lodged in the PCD body more quickly than nanoparticles having a size considerably smaller than the average pore throat size. In embodiments, controlling the depth and extent of infiltration/infusion may include selecting a desired combination of one or more of average diamond particle size; diamond layer number, thickness, and average diamond particle size; catalyst material amount and type used in the first HPHT sintering; first HPHT sintering conditions; leaching depth; nanoparticle type and size; and fluid type, density and viscosity.

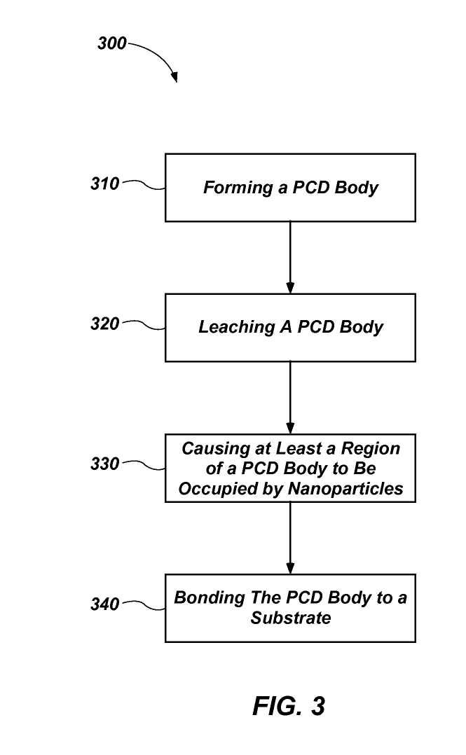

FIG. 3 is a flow diagram of a method 300 of making a PDC according to an embodiment. The method 300 of making a PDC is not intended to limit the acts of forming, leaching, infiltrating, and bonding infiltrated PCD bodies described herein to particular embodiments or combinations of embodiments, but is intended to provide a basic framework for understanding a method of making a PDC according to some of the many varied individual acts disclosed herein. While not explicitly referred to as acts or parts of a single method, embodiments of the acts of method 300 have been described herein. Accordingly, any of the acts described herein may be used in concert with each other to form the PDC 100.

The method 300 of making a PDC includes an act 310 of forming a PCD body, and act 320 of leaching the PCD body, an act 330 of causing at least a region of the PCD body to be occupied by nanoparticles, and an act 340 of bonding the PCD body to a substrate.

In an embodiment, the act 310 of forming a PCD body may include subjecting diamond particles having an average particle size of about 20 μm having metal-solvent catalyst powder comprising cobalt dispersed therein, to a first HPHT process including a cell pressure of about 7.7 GPa and a temperature of about 1400° C. In an embodiment a larger average diamond particle size may be used, for example, the average diamond particle size may be about 30 μm. In an embodiment, a multimodal diamond powder mixture may be used, for example, diamond powders exhibiting an average diamond particle size of 20 μm and 40 μm respectively may be mixed together. In an embodiment, the cell pressure may be higher, for example, about 9 GPa may be used to form a PCD body. In an embodiment, a higher temperature may be used in the first HPHT process, for example, above about 1500° C. In another embodiment, the act 310 of forming a PCD body may include subjecting diamond particles having an average particle size of about 20 μm positioned adjacent to a cobalt cemented tungsten-carbide substrate in a pressure transmitting medium to the first HPHT described above. The resulting PCD body 122 may be separated from the substrate by one of lapping, EDM machining, or grinding.

In an embodiment of the act 320 of leaching a PCD body, the PCD body 122 having catalyst therein may be leached by exposure to acid in a leaching vessel. The acid may be at a temperature above ambient temperature, for example above about 30° C. or above about 100° C. In an embodiment, the rinsing vessel may be sealed and the acid disposed therein may be subjected to elevated pressure. The elevated pressure may be created by heat applied to the leaching vessel and/or acid thereby increasing vapor pressure in the leaching vessel. In an embodiment, the leaching agent may be one or more of hydrochloric acid, nitric acid, hydrofluoric acid, or aqua regia. In embodiments, the leaching time may be about 4 weeks, 2 weeks, a week, 5 days, 3 days, 2 days, or 1 day. In an embodiment, the resulting at least partially leached PCD body 124 may be cleaned to remove the leaching agent and/or leaching agent by-product by exposure to water for more than a day. Further cleaning processes, HPHT processes, and resultant PDCs may be formed according to the techniques disclosed in U.S. Pat. No. 7,845,438, which is incorporated herein, its entirety, by this reference.

In an embodiment of the act 330 causing at least a region of a PCD body to be occupied by nanoparticles, the at least partially leached PCD body 124 may be infiltrated with the nanoparticles 210. In an embodiment, nanoparticles 210 may include one or more of UDD particles, metal oxides, metal nitrides, metal carbides, glass, silicon, silicone, or copper. In an embodiment, the nanoparticles 210 may exhibit an average size of more than about 1 nm, such as about 5 nm, about 25 nm, about 50 nm, about 100 nm, about 500 nm, about 1000 nm, about 5 nm to about 1000 nm, or about 10 nm to about 500 nm. The nanoparticles 210 may be suspended in a fluid 215. In an embodiment, suitable fluids 210 may include commonly known or recognized fluids which do not degrade or dissolve the nanoparticles or diamond, such as by way of non-limiting example water, alcohol, DCM, THF, DMSO, or combinations thereof. In embodiments, the nanoparticles 210 may be mixed in the fluid 215 in such a manner as to create a substantially uniform distribution of the nanoparticles 210 in the fluid 215.

In an embodiment, the act 330 of causing at least a region of a PCD body to be occupied by nanoparticles may include placing the at least partially leached PCD body 124, substantially as depicted in FIG. 1D, into the infiltration apparatus 200, such as, the embodiment depicted in FIG. 2A. The at least partially leached PCD body 124 may be placed in the infiltration apparatus 200 with at least one surface exposed to the interior volume 235, such as the upper surface 130 being exposed to the interior volume 235. The at least partially leached PCD body 124 having interconnected interstitial spaces therein may effectively seal the interior volume 235 of the infiltration apparatus 200 from the environment outside of the infiltration apparatus, wherein the fluid 215 having nanoparticles 210 therein may be disposed in the interior volume 235. In embodiments, the fluid 215 and nanoparticles 210 may be supplied to the interior volume 235 before or after the PCD body has been placed in the infiltration apparatus 200. In an embodiment, the at least partially leached PCD body 124 may be placed in the retaining ring 240, with or without a sealing element 250, wherein the retaining ring may be attached to the at least on side wall 220. While the PCD bodies disclosed therein have been depicted as having a substantially cylindrical geometry, all PCD body geometries are contemplated, whereby the infiltration apparatus may be of a complementary configuration to the non-cylindrical embodiment of the PCD, such that the embodiments depicted herein may be practiced in similar manners to that of the cylindrical PCD body.

In an embodiment of the act 330 of causing at least a region of a PCD body to be occupied by nanoparticles, the pressure exerted on the fluid 215 having nanoparticles therein may be elevated. The elevated pressure causes the fluid 215 having the nanoparticles 210 suspended therein to diffuse through the interconnected interstitial spaces of the at least partially leached PCD body 124 toward the low pressure on the outside of the infiltrating vessel, thereby infiltrating the PCD body 124 with nanoparticles as they become trapped or otherwise stopped in the empty interstitial spaces of the PCD body 124. In embodiments, the pressure exerted on the fluid having nanoparticles suspended therein may range from about 0.102 MPa to about 350 MPa. The act 330 of causing at least a region of a PCD body to be occupied by nanoparticles may include elevating the pressure exerted on the fluid 215 having nanoparticles to a pressure and for a duration sufficient to achieve the desired depth and/or density of infiltration, by way of non-limiting example, at about 100 MPa for about 1 hour. Sufficient durations may include more than about 30 seconds, such as about 1 minute, about 3 minutes, about 5 minutes, about 10 minutes, about 30 minutes, about 1 hour, about 2 hours, about 24 hours, about 1 minute to about 1 hour, about 2 minutes to about 30 minutes, or less than 24 hours. Infiltration duration may be tailored according to infiltration pressure, nanoparticle size, fluid properties, PCD body density, desired infiltration depth, and combinations thereof. In such an embodiment, only a portion of the PCD body may be infiltrated (e.g., from the upper surface 130 to an intermediate depth d). In an embodiment, the act 330 of causing at least a region of a PCD body to be occupied by nanoparticles may include disposing the nanoparticles 210 in the fluid 215 for only a portion of the time the fluid 210 is infiltrated through the PCD body. In such an embodiment, the resulting PCD body 126′ (substantially as depicted in FIG. 1H) may include the nanoparticle-containing region 127 extending between the intermediate depth d nearer the back surface 140 and the upper intermediate depth d′ nearer the upper surface 130. In an embodiment, the act 330 of causing at least a region of a PCD body to be occupied by nanoparticles may include elevating the pressure and/or using a fluid and/or nanoparticle size to achieve a desired fluid flow rate through the PCD body.

In an embodiment of the act 340, the at least partially leached and infiltrated PCD body 126 may be bonded to a substrate. Bonding the at least partially leached and infiltrated PCD body 126 to a substrate 150 may include using a second HPHT process and/or brazing. In an embodiment, the at least partially leached and infiltrated PCD body 126 (substantially as depicted in any of FIGS. 1E, 1H, and 1J) may be bonded to the substrate 150 using a second HPHT process having a cell pressure and/or temperature less than that of the first HPHT process used to form the PCD body 122. In an embodiment, the at least partially leached and infiltrated PCD body 126 may be placed in a pressure transmitting medium adjacent to a cobalt-cemented tungsten-carbide substrate 150, and subjected to second HPHT conditions in which the cobalt in the substrate at least partially melts and sweeps into the empty interstitial spaces of the PCD body 126.

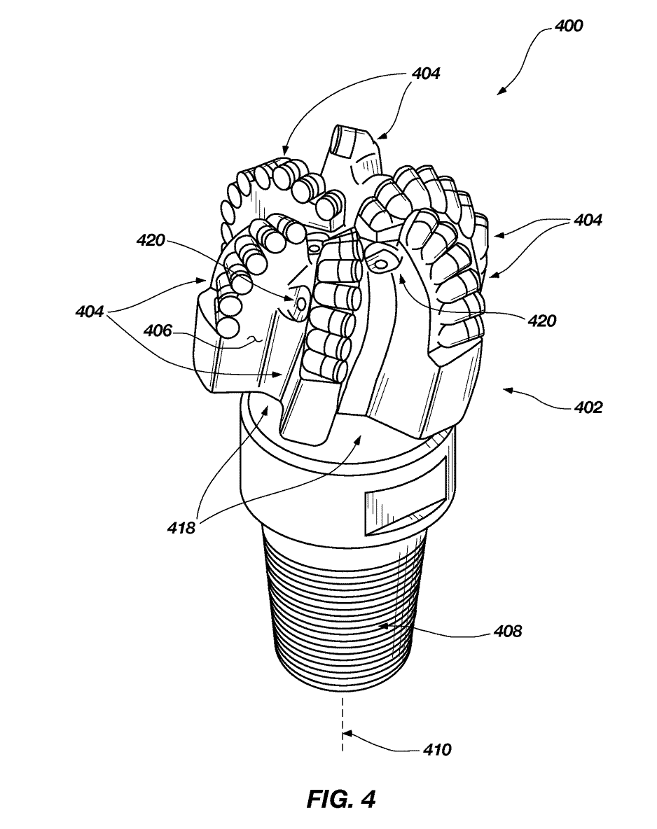

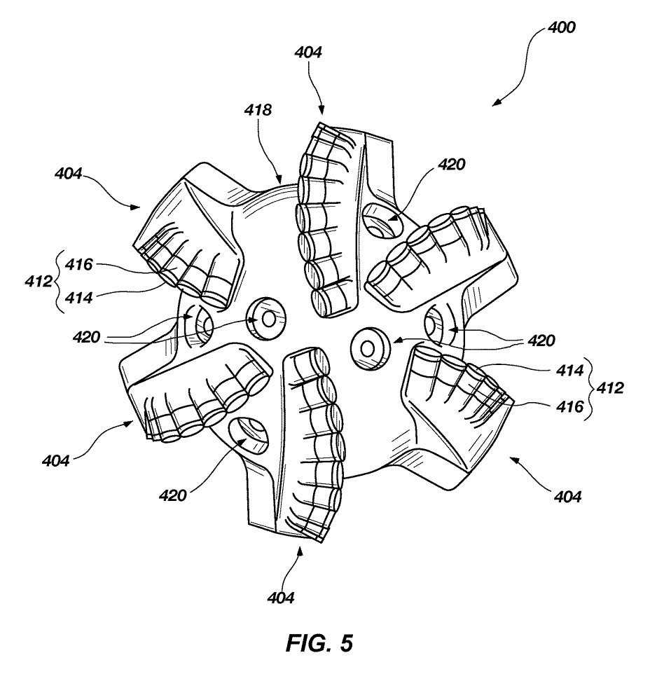

FIG. 4 is an isometric view and FIG. 5 is a top elevation view of a rotary drill bit 400 according to an embodiment. The rotary drill bit 400 includes at least one PDC fabricated according to any of the previously described PDC embodiments. The rotary drill bit 400 comprises a bit body 402 that includes radially and longitudinally extending blades 404 with leading faces 406, and a threaded pin connection 408 for connecting the bit body 402 to a drilling string. The bit body 402 defines a leading end structure configured for drilling into a subterranean formation by rotation about a longitudinal axis 410 and application of weight-on-bit. At least one PDC cutting element, manufactured and configured according to any of the previously described PDC embodiments (e.g., any of the PDCs shown in FIGS. 1A, 1I, and 1N), may be affixed to rotary drill bit 400 by, for example, brazing, mechanical affixing, or another suitable technique. With reference to FIG. 5, each of a plurality of PDCs 412 is secured to the blades 404. For example, each PDC 412 may include a PCD body 414 bonded to a substrate 416. More generally, the PDCs 412 may comprise any PDC disclosed herein, without limitation. In addition, if desired, in an embodiment, a number of the PDCs 412 may be conventional in construction. Also, circumferentially adjacent blades 404 define so-called junk slots 418 therebetween, as known in the art. Additionally, the rotary drill bit 400 includes a plurality of nozzle cavities 420 for communicating drilling fluid from the interior of the rotary drill bit 400 to the PDCs 412.

FIGS. 4 and 5 merely depict one embodiment of a rotary drill bit that employs at least one cutting element comprising a PDC fabricated and structured in accordance with the disclosed embodiments, without limitation. The rotary drill bit 400 is used to represent any number of earth-boring tools or drilling tools, including, for example, core bits, roller cone bits, fixed cutter bits, eccentric bits, bicenter bits, reamers, reamer wings, mining rotary drill bits, or any other downhole tool including PDCs, without limitation.

The PDCs disclosed herein may also be utilized in applications other than rotary drill bits. For example, the disclosed PDC embodiments may be used in thrust-bearing assemblies, radial bearing assemblies, wire-drawing dies, artificial joints, machining elements, PCD windows, and heat sinks.

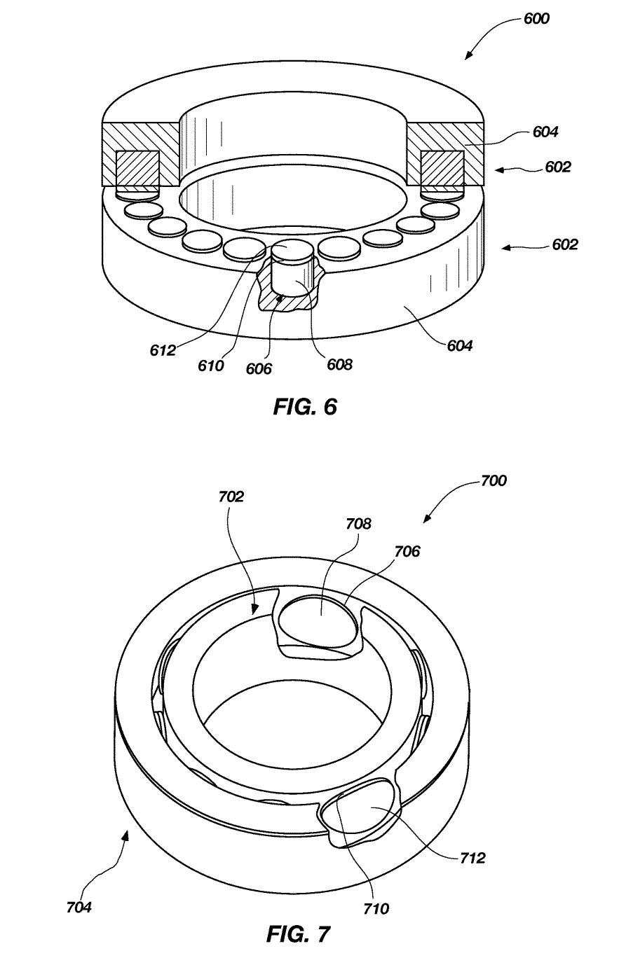

FIG. 6 is an isometric cut-away view of a thrust-bearing apparatus 600 according to an embodiment, which may utilize any of the disclosed PDC embodiments as bearing elements. The thrust-bearing apparatus 600 includes respective thrust-bearing assemblies 602. Each thrust-bearing assembly 602 includes an annular support ring 604 that may be fabricated from a material, such as carbon steel, stainless steel, or another suitable material. Each support ring 604 includes a plurality of recesses (not labeled) that receives a corresponding bearing element 606. Each bearing element 606 may be mounted to a corresponding support ring 604 within a corresponding recess by brazing, press-fitting, using fasteners, combinations thereof, or another suitable mounting technique. One or more, or all of bearing elements 606 may be manufactured and configured according to any of the disclosed PDC embodiments. For example, each bearing element 606 may include a substrate 608 and a PCD body 610, with the PCD body 510 including a bearing surface 612.

In use, the bearing surfaces 612 of one of the thrust-bearing assemblies 602 bears against the opposing bearing surfaces 612 of the other one of the bearing assemblies 602. For example, one of the thrust-bearing assemblies 602 may be operably coupled to a shaft to rotate therewith and may be termed a “rotor.” The other one of the thrust-bearing assemblies 602 may be held stationary and may be termed a “stator.”

FIG. 7 is an isometric cut-away view of a radial bearing apparatus 700 according to an embodiment, which may utilize any of the disclosed PDC embodiments as bearing elements. The radial bearing apparatus 700 includes an inner race 702 positioned generally within an outer race 704. The outer race 704 includes a plurality of bearing elements 706 affixed thereto that have respective bearing surfaces 708. The inner race 702 also includes a plurality of bearing elements 710 affixed thereto that have respective bearing surfaces 712. One or more, or all of the bearing elements 706 and 710 may be configured according to any of the PDC embodiments disclosed herein. The inner race 702 is positioned generally within the outer race 704, with the inner race 702 and outer race 704 configured so that the bearing surfaces 708 and 712 may at least partially contact one another and move relative to each other as the inner race 702 and outer race 704 rotate relative to each other during use.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

1. A method of forming a polycrystalline diamond compact, comprising:
subjecting a plurality of diamond particles to a first high-pressure/high-temperature process in the presence of a metal-solvent catalyst to form a polycrystalline diamond body, the polycrystalline diamond body including a plurality of diamond grains exhibiting diamond-to-diamond bonding therebetween defining a plurality of interstitial spaces including the metal-solvent catalyst therein;
leaching the polycrystalline diamond body to at least partially remove the metal-solvent catalyst from at least a portion of the plurality of interstitial spaces to form an at least partially leached polycrystalline diamond body having an upper surface and a back surface spaced therefrom;
causing at least a portion of the plurality of interstitial spaces of the at least partially leached polycrystalline diamond body to be occupied by a quantity of nanoparticles;
bonding the at least partially leached and nanoparticle-containing polycrystalline diamond body to a substrate by subjecting the substrate having a constituent infiltrant disposed therein and the at least partially leached and nanoparticle containing polycrystalline diamond body to a second high-pressure/high-temperature process effective to infiltrate the at least partially leached and nanoparticle-containing polycrystalline diamond body with the constituent infiltrant from the substrate.

2. The method of claim 1, wherein causing at least a portion of the plurality of interstitial spaces of the at least partially leached polycrystalline diamond body to be occupied by a quantity of nanoparticles includes causing the at least partially leached polycrystalline diamond body to be occupied by a quantity nanoparticles from the upper surface to an intermediate depth therein.

3. The method of claim 1, wherein causing at least a portion of the plurality of interstitial spaces of the at least partially leached polycrystalline diamond body to be occupied by a quantity of nanoparticles includes placing the at least partially leached polycrystalline diamond body in a nanoparticle infiltration apparatus with the upper surface thereof exposed to an interior volume of the nanoparticle infiltration apparatus.

4. The method of claim 3, wherein causing at least a portion of the plurality of interstitial spaces of the at least partially leached polycrystalline diamond body to be occupied by a quantity of nanoparticles includes supplying a fluid having the nanoparticles dispersed therein into the interior volume and applying pressure to the fluid such that the fluid is diffused into the least a portion of the plurality of interstitial spaces of the at least partially polycrystalline diamond body, thereby carrying the nanoparticles into the at least partially leached polycrystalline diamond body.

5. The method of claim 4, wherein causing at least a portion of the plurality of interstitial spaces of the at least partially leached polycrystalline diamond body to be occupied by a quantity of nanoparticles includes supplying nanoparticles to the fluid during diffusion for so long as to infiltrate a region of the at least partially leached polycrystalline diamond body to an intermediate depth nearer to the back surface and an upper intermediate depth nearer to the upper surface.

6. The method of claim 4, wherein the back surface of the at least partially polycrystalline diamond body is exposed to an environment outside of the nanoparticle infiltration apparatus.

7. The method of claim 4, wherein the pressure applied to the fluid having the nanoparticles dispersed therein is above about 50 MPa.

8. The method of claim 1, wherein the nanoparticles include ultra-dispersed diamond particles, copper, silicon, silicone, aluminum, boron or combinations thereof.

9. The method of claim 1, wherein the nanoparticles include a material having a negative coefficient of thermal expansion.

10. The method of claim 7, wherein the fluid is a liquid.

11. A method of forming a polycrystalline diamond compact, comprising:
subjecting a plurality of diamond particles to a first high-pressure/high-temperature process in the presence of a metal-solvent catalyst to form a polycrystalline diamond body, the polycrystalline diamond body including a plurality of diamond grains exhibiting diamond-to-diamond bonding therebetween defining a plurality of interstitial spaces including the metal-solvent catalyst therein;
leaching the polycrystalline diamond body to at least partially remove the metal-solvent catalyst from at least a portion of the plurality of interstitial spaces to form an at least partially leached polycrystalline diamond body having an upper surface and a back surface spaced therefrom;
causing at least a portion of the at least partially leached polycrystalline diamond body to be occupied by nanoparticles including:
exposing the polycrystalline diamond body to a pressurized fluid including nanoparticles therein, such that at least a portion of the nanoparticles are infused into the plurality of interstitial spaces of the at least a portion of the polycrystalline diamond body; and
bonding the at least partially leached and nanoparticle-containing polycrystalline diamond body to a substrate by subjecting the at least partially leached and nanoparticle containing polycrystalline diamond body and the substrate to a second high-pressure/high-temperature process effective to infiltrate at least a portion of the at least partially leached and nanoparticle-containing polycrystalline diamond body with a constituent infiltrant from the substrate.

12. The method of claim 11, wherein exposing the polycrystalline diamond body to a pressurized fluid including nanoparticles therein includes exposing the polycrystalline diamond body to a pressure of at least about 100 MPa.

13. The method of claim 11, wherein exposing the polycrystalline diamond body to a pressurized fluid including nanoparticles therein includes exposing the polycrystalline diamond body to a pressure of at least about 300 MPa.

14. The method of claim 11, wherein the nanoparticles include one or more of ultra-dispersed diamond particles, copper, silicon, silicone, or materials having a negative coefficient of thermal expansion.

15. The method of claim 11, wherein causing at least a portion of the at least partially leached polycrystalline diamond body to be occupied by nanoparticles includes causing an annular region extending about the periphery of the polycrystalline diamond body to be occupied by nanoparticles.

16. The method of claim 15 wherein, the annular region extending about the periphery of the polycrystalline diamond body to be occupied by nanoparticles is infiltrated from a lateral surface thereof.

17. The method of claim 11, further comprising forming a chamfer between the lateral surface and the upper surface.

18. The method of claim 17, wherein causing at least a portion of the at least partially leached polycrystalline diamond body to be occupied by nanoparticles includes causing an annular region extending about the periphery of the PCD body including the chamfer to be occupied by nanoparticles from the chamfer therein.

19. The method of claim 1, wherein bonding the at least partially leached and nanoparticle-containing polycrystalline diamond body to a substrate by subjecting the at least partially leached and nanoparticle-containing polycrystalline diamond body to a second high-pressure/high-temperature process effective to infiltrate the at least a portion of the at least partially leached nanoparticle-containing polycrystalline diamond body includes infiltrating the at least partially leached nanoparticle-containing polycrystalline diamond body with a constituent infiltrant disposed in the substrate.

20. A polycrystalline diamond compact, comprising:
a substrate including an interfacial surface and a constituent infiltrant disposed therein; and
a polycrystalline diamond body having an upper surface, a back surface spaced from the upper surface and bonded to the interfacial surface of the substrate, and a lateral surface extending between the upper surface and the back surface, the polycrystalline diamond body including:
a plurality of bonded diamond grains defining plurality of interstitial spaces therebetween;
an infiltrated region extending from the back surface to an intermediate depth, the infiltrated region including a constituent infiltrant occupying at least a portion of the plurality of interstitial spaces therein; and
a nanoparticle containing region extending from at least the intermediate depth toward the upper surface, the nanoparticle containing region having nanoparticles occupying at least a portion of the plurality of interstitial spaces therein.

21. The polycrystalline diamond compact of claim 20, wherein the polycrystalline diamond body includes an upper region extending from the upper surface toward the nanoparticle-containing region, the upper region including substantially none of the nanoparticles.

22. The polycrystalline diamond compact of claim 20, wherein the nanoparticles in the nanoparticle-containing region exhibit a concentration gradient in which a concentration of the nanoparticles therein decreases toward the infiltrated region.

23. The polycrystalline diamond compact of claim 20, wherein the nanoparticles include nanodiamond particles, metals, metalloids, metal oxides, metal carbides, metal nitrides, glass, aluminum, copper, boron, silicon, or combinations thereof.

24. The polycrystalline diamond compact of claim 20, the nanoparticle-containing region extends peripherally about the PCD body in an annular configuration.

25. The polycrystalline diamond compact of claim 20, wherein the annular region includes a chamfer between the lateral surface and the upper surface.

26. The polycrystalline diamond compact of claim 23 wherein the annular region includes a chamfer between the lateral surface and the upper surface.

27. The polycrystalline diamond compact of claim 20 wherein the nanoparticle-containing region is substantially proximate to a chamfer formed between the lateral surface and the upper surface.

28. The polycrystalline diamond compact of claim 1 wherein the nanoparticles include diamond particles.
